(19) United States
(12) Patent Application Publication
(10) Pub. No.: US 2026/0227249 A1
(43) Pub. Date: Aug. 6, 2026

(54) TEMPERATURE MEASUREMENT METHOD

(71) Applicant: Asahi Kasei Microdevices Corporation, Tokyo (JP)

(72) Inventors: Masashi Higashino, Tokyo (JP); Yuta Takagi, Tokyo (JP)

(73) Assignee: Asahi Kasei Microdevices Corporation, Tokyo (JP)

(21) Appl. No.: 19/530,270

(22) Filed: Feb. 4, 2026

(30) Foreign Application Priority Data
Feb. 6, 2025 (JP) 2025-018337
Dec. 17, 2025 (JP) 2025-261287

(51) Int. Cl. G01K 13/20; G01K 7/18

(52) U.S. Cl. CPC G01K 13/223; G01K 7/18

(57) ABSTRACT

Provided is a temperature measurement method including: a step in which a contactless type temperature measurement unit of a temperature measurement device measures a temperature of a measurement target to acquire contactless measurement data; a step of determining a time point at which the temperature measurement device contacts the measurement target; and a step of calculating the temperature of the measurement target based on the contactless measurement data during a predetermined time window for temperature calculation before or until the time point determined as the time point at which the temperature measurement device contacts the measurement target.

### CROSS-REFERENCE TO RELATED APPLICATION

This application claims the priority benefit of Japanese application serial No. 2025-018337, filed on Feb. 6, 2025 and Japanese application serial No. 2025-261287, filed on Dec. 17, 2025. The entirety of each of the above-mentioned patent applications is hereby incorporated by reference herein and made a part of this specification.

### BACKGROUND

### Technical Field

The invention relates to a temperature measurement method.

### Description of Related Art

Patent Document 1 describes “an electronic thermometer with a cover that includes a plurality of temperature measurement units including at least a contact type temperature measurement unit, and in the case of performing a body temperature measurement using only one of the temperature measurement units, can prevent occurrence of thermal disturbance without increasing burden on the user, and can always perform accurate body temperature measurement”.

### Prior Art Document(s)

### Patent Document(s)

[Patent Document 1] Japanese Patent Application Laid-Open No. 2013-170935
[Patent Document 2] Japanese Patent Application Laid-Open No. 2013-190207

### SUMMARY

An aspect of the invention provides a temperature measurement method. The temperature measurement method includes: a step of measuring, by a contactless type temperature measurement unit of a temperature measurement device, a temperature of a measurement target to acquire contactless measurement data; a step of determining a time point at which the temperature measurement device contacts the measurement target; and a step of calculating the temperature of the measurement target based on the contactless measurement data during a predetermined time window for temperature calculation before or until a time point determined as the time point at which the temperature measurement device contacts the measurement target.

The above summary of the invention does not enumerate all of the features of the invention. Also, sub-combinations of these feature groups may also constitute inventions.

### BRIEF DESCRIPTION OF THE DRAWINGS

FIG. 1A is an example illustrating a configuration of a temperature measurement device 100 together with a measurement target 10.

FIG. 1B illustrates an example of the temperature measurement device 100.

FIG. 2A illustrates an example of a temperature measurement method.

FIG. 2B illustrates an example of Step S100 of acquiring contactless measurement data.

FIG. 3A illustrates an example of temporal changes of measurement data.

FIG. 3B illustrates an example of changes of measurement data over a longer period including a measurement period of FIG. 3A.

FIG. 4 illustrates an example of temporal changes of measurement data.

FIG. 5 illustrates an example of a semiconductor package 200.

FIG. 6A illustrates a modified example of a configuration of the temperature measurement device 100 together with a measurement target 10.

FIG. 6B illustrates a modified example of the temperature measurement device 100.

FIG. 7A illustrates a modified example of a configuration of the temperature measurement device 100 together with the measurement target 10.

FIG. 7B illustrates a modified example of the temperature measurement device 100.

FIG. 8A illustrates an example of temporal changes of measurement data.

FIG. 8B illustrates an example of temporal changes of measurement data in a longer period including a measurement period of FIG. 8A.

FIG. 9A illustrates a modified example of a configuration of the temperature measurement device 100 together with the measurement target 10.

FIG. 9B illustrates a modified example of the temperature measurement device 100.

FIG. 10A illustrates a modified example of a configuration of the temperature measurement device 100 together with the measurement target 10.

FIG. 10B is a modified example of the temperature measurement device 100.

FIG. 10C is a modified example of the temperature measurement device 100.

FIG. 11 is an example of temporal changes of measurement data.

FIG. 12A illustrates a modified example of a configuration of the temperature measurement device 100 together with the measurement target 10.

FIG. 12B illustrates a modified example of the temperature measurement device 100.

FIG. 12C illustrates a modified example of the temperature measurement device 100.

FIG. 13A illustrates a modified example of a configuration of the temperature measurement device 100 together with the measurement target 10.

FIG. 13B illustrates a modified example of the temperature measurement device 100.

FIG. 14A illustrates an example of temporal changes of measurement data and a contact detection signal.

FIG. 14B illustrates an example of temporal changes of measurement data and a contact detection signal.

FIG. 15A illustrates a modified example of a configuration of the temperature measurement device 100 together with the measurement target 10.

FIG. 15B illustrates a modified example of the temperature measurement device 100.

FIG. 16 illustrates an example of a configuration of the temperature measurement device 100 together with the measurement target 10.

FIG. 17 illustrates an example of the temperature measurement method.

FIG. 18 illustrates an example of a computer 1000 in which multiple aspects of the invention may be embodied in whole or in part.

### DESCRIPTION OF THE EMBODIMENTS

In a first aspect of the invention, a temperature measurement method is provided. The method includes: a step in which a contactless type temperature measurement unit of a temperature measurement device measures a temperature of a measurement target to acquire contactless measurement data; a step of determining a time point at which the temperature measurement device contacts the measurement target; and a step of calculating the temperature of the measurement target based on the contactless measurement data of a predetermined time window for temperature calculation before or until a time point determined as the time point at which the temperature measurement device contacts the measurement target.

In the temperature measurement method, the step of calculating the temperature of the measurement target may include a step of calculating the temperature of the measurement target based on either the maximum or the minimum of temporal changes of the contactless measurement data during the time window for temperature calculation.

The temperature measurement method according to any of the above may include a step in which a contact type temperature measurement unit of the temperature measurement device measures the temperature of the measurement target to acquire contact measurement data. In the temperature measurement method according to any of the above, the step of determining the time point at which the temperature measurement device contacts the measurement target may include a step of determining the time point at which the temperature measurement device contacts the measurement target based on the contact measurement data.

The temperature measurement method according to any of the above may include a step in which a contact type temperature measurement unit of the temperature measurement device measures the temperature of the measurement target to acquire contact measurement data. In the temperature measurement method according to any of the above, the step of determining the time point at which the temperature measurement device contacts the measurement target may include a step of determining the time point at which the temperature measurement device contacts the measurement target based on both the contact measurement data and the contactless measurement data.

The temperature measurement method according to any of the above may include a step in which a contact type temperature measurement unit of the temperature measurement device measures the temperature of the measurement target to acquire contact measurement data. In the temperature measurement method according to any of the above, the step of calculating the temperature of the measurement target may include a step of calculating the temperature of the measurement target based on the contactless measurement data and the contact measurement data.

In the temperature measurement method according to any of the above, the step of acquiring the contactless measurement data may include a step of acquiring the contactless measurement data in a state where the temperature measurement device does not contact the measurement target, and a step of acquiring the contactless measurement data in a state where the temperature measurement device contacts the measurement target.

In the temperature measurement method according to any of the above, the step of calculating the temperature of the measurement target may include a step of calculating the temperature of the measurement target based on temporal changes of the contactless measurement data and the contact measurement data.

In the temperature measurement method according to any of the above, the step of determining the time point at which the temperature measurement device contacts the measurement target may include a step of determining a time point at which the contactless measurement data decreases and the contact measurement data increases as the time point at which the temperature measurement device contacts the measurement target.

The temperature measurement method according to any of the above may include a step of notifying an error in a case where an amount of change of the contact measurement data acquired by the contact type temperature measurement unit does not exceed a predetermined error reference value within a predetermined error determination period.

In the temperature measurement method according to any of the above, the step of acquiring the contactless measurement data may include a step in which a first contactless type temperature measurement unit of the temperature measurement device measures the temperature of the measurement target to acquire first contactless measurement data, and a step in which a second contactless type temperature measurement unit of the temperature measurement device measures the temperature of the measurement target to acquire second contactless measurement data.

In the temperature measurement method according to any of the above, the step of calculating the temperature of the measurement target may include a step of calculating the temperature of the measurement target based on the first contactless measurement data and the second contactless measurement data.

The temperature measurement method according to any of the above may include a step in which a contact detection unit of the temperature measurement device determines a contact state with the measurement target and outputs a contact detection signal.

In the temperature measurement method according to any of the above, the step of determining the time point at which the temperature measurement device contacts the measurement target may include a step of determining the time point at which the temperature measurement device contacts the measurement target based on the contact detection signal.

In the temperature measurement method according to any of the above, the time window for temperature calculation may be greater than 0 seconds and equal to or less than 15 seconds.

In the temperature measurement method according to any of the above, the step of calculating the temperature of the measurement target may include a step of calculating the temperature of the measurement target as a value of 95% or more and 110% or less of any one of the maximum or the minimum of the contactless measurement data.

In the temperature measurement method according to any of the above, the step of acquiring the contactless measurement data may include a step of acquiring the contactless measurement data at a time interval of 0.004 seconds or more and 5 seconds or less.

In the temperature measurement method according to any of the above, the contactless type temperature measurement unit and the contact type temperature measurement unit may be provided in a common semiconductor package.

In the temperature measurement method according to any of the above, the contactless type temperature measurement unit may have a quantum type infrared sensor.

In the temperature measurement method according to any of the above, the measurement target may be a living organism.

In a second aspect of the invention, a temperature measurement device is provided. The temperature measurement device includes: a contactless type temperature measurement unit that measures a temperature of a measurement target and acquires contactless measurement data; and a calculation unit that calculates the temperature of the measurement target based on the contactless measurement data.

In the temperature measurement device, the calculation unit may determine a time point at which the temperature measurement device contacts the measurement target, and calculate the temperature of the measurement target based on the contactless measurement data during a predetermined time window for temperature calculation before or until a time point determined as the time point at which the temperature measurement device contacts the measurement target.

In the temperature measurement device according to any of the above, the calculation unit may calculate the temperature of the measurement target based on any of the maximum or the minimum of temporal changes of the contactless measurement data during the time window for temperature calculation.

The temperature measurement device according to any of the above may include a contact type temperature measurement unit that measures the temperature of the measurement target and acquires contact measurement data.

In the temperature measurement device according to any of the above, the calculation unit may determine the time point of contacting the measurement target based on the contact measurement data.

The temperature measurement device according to any of the above may include a contact type temperature measurement unit that measures the temperature of the measurement target and acquires contact measurement data.

In the temperature measurement device according to any of the above, the calculation unit may determine the time point of contacting the measurement target based on both the contact measurement data and the contactless measurement data.

The temperature measurement device according to any of the above may include a contact type temperature measurement unit that measures the temperature of the measurement target and acquires contact measurement data.

In the temperature measurement device according to any of the above, the calculation unit may calculate the temperature of the measurement target based on the contactless measurement data and the contact measurement data.

In the temperature measurement device according to any of the above, the calculation unit may calculate the temperature of the measurement target based on temporal changes of the contactless measurement data and the contact measurement data.

In the temperature measurement device according to any of the above, the calculation unit may determine a time point at which the contactless measurement data decreases and the contact measurement data increases as the time point at which the temperature measurement device contacts the measurement target.

The temperature measurement device according to any of the above may notify an error in a case where the amount of change of the contact measurement data acquired by the contact type temperature measurement unit does not exceed a predetermined error reference value within a predetermined error determination period.

In the temperature measurement device according to any of the above, the contactless type temperature measurement unit may include: a first contactless type temperature measurement unit that measures the temperature of the measurement target and acquires first contactless measurement data, and a second contactless type temperature measurement unit that measures the temperature of the measurement target and acquires second contactless measurement data.

In the temperature measurement device according to any of the above, the calculation unit may calculate the temperature of the measurement target based on the first contactless measurement data and the second contactless measurement data.

The temperature measurement device according to any of the above may include a contact detection unit that determines a contact state with the measurement target and outputs a contact detection signal.

In the temperature measurement device according to any of the above, the calculation unit may determine the time point of contacting the measurement target based on the contact detection signal.

In the temperature measurement device according to any of the above, the time window for temperature calculation may be greater than 0 seconds and equal to or less than 15 seconds.

In the temperature measurement device according to any of the above, the calculation unit may calculate the temperature of the measurement target as a value of 95% or more and 110% or less of any one of the maximum or the minimum of the contactless measurement data.

In the temperature measurement device according to any of the above, the contactless type temperature measurement unit may acquire the contactless measurement data at a time interval of 0.004 seconds or more and 5 seconds or less.

In the temperature measurement device according to any of the above, the contactless type temperature measurement unit and the contact type temperature measurement unit may be provided in a common semiconductor package.

In the temperature measurement device according to any of the above, a distance between the contactless type temperature measurement unit and the contact type temperature measurement unit may be within 3 cm.

In the temperature measurement device according to any of the above, the contactless type temperature measurement unit may have a quantum type infrared sensor.

In a third aspect of the invention, a program is provided. When executed by a computer, the program causes the computer to: control a contactless type temperature measurement unit of a temperature measurement device to measure a temperature of a measurement target and acquire contactless measurement data; determine a time point at which the temperature measurement device contacts the measurement target; and calculate the temperature of the measurement target based on the contactless measurement data during a predetermined time window for temperature calculation before or until a time point determined as the time point at which the temperature measurement device contacts the measurement target.

When executed by the computer, the program may cause the computer to: control a contact type temperature measurement unit of the temperature measurement device to measure the temperature of the measurement target and acquire contact measurement data; and calculate the temperature of the measurement target based on the contact measurement data and the contactless measurement data.

In the program according to any of the above, causing the contactless type temperature measurement unit of the temperature measurement device to acquire the contactless measurement data may include: causing a first contactless type temperature measurement unit of the temperature measurement device to measure the temperature of the measurement target and acquire first contactless measurement data; and causing a second contactless type temperature measurement unit of the temperature measurement device to measure the temperature of the measurement target and acquire second contactless measurement data.

When executed by the computer, the program according to any of the above may cause the computer to calculate the temperature of the measurement target based on the first contactless measurement data and the second contactless measurement data.

When executed by the computer, the program may cause the computer to: control a contact detection unit of the temperature measurement device to determine a contact state with the measurement target and output a contact detection signal; and determine the time point of contacting the measurement target based on the contact detection signal.

In a fourth aspect of the invention, a temperature measurement method is provided, including: a step in which a contactless type temperature measurement unit of a temperature measurement device measures a temperature of a measurement target and acquires contactless measurement data; a step in which a contact type temperature measurement unit of the temperature measurement device measures the temperature of the measurement target and acquires contact measurement data; and a step of calculating the temperature of the measurement target based on the contactless measurement data and the contact measurement data.

In the temperature measurement method according to any of the above, the step of acquiring the contactless measurement data may include: a step of acquiring the contactless measurement data in a state where the temperature measurement device does contact the measurement target; and a step of acquiring the contactless measurement data in a state where the temperature measurement device contacts the measurement target.

In the temperature measurement method according to any of the above, the step of calculating the temperature of the measurement target may include a step of calculating the temperature of the measurement target based on temporal changes of the contactless measurement data and the contact measurement data.

In the temperature measurement method according to any of the above, the step of calculating the temperature of the measurement target may include a step of calculating the temperature of the measurement target based on temporal changes during a predetermined time window for temperature calculation before or until the time point at which the contactless measurement data decreases and the contact measurement data increases.

In the temperature measurement method according to any of the above, the time window for temperature calculation may be greater than 0 seconds and equal to or less than 15 seconds.

In the temperature measurement method according to any of the above, the step of calculating the temperature of the measurement target may include a step of calculating the temperature of the measurement target based on the maximum of the contactless measurement data during the time window for temperature calculation

In the temperature measurement method according to any of the above, the step of calculating the temperature of the measurement target may include a step of calculating the temperature of the measurement target as a value of 95% or more and 110% or less of the maximum of the contactless measurement data.

In the temperature measurement method according to any of the above, the step of acquiring the contactless measurement data may include a step of acquiring the contactless measurement data at a time interval of 0.004 seconds or more and 5 seconds or less.

The temperature measurement method according to any of the above may include a step of notifying an error in a case where an amount of change of the contact measurement data acquired by the contact type temperature measurement unit does not exceed a predetermined error reference value within a predetermined error determination period.

In the temperature measurement method according to any of the above, the contactless type temperature measurement unit and the contact type temperature measurement unit may be provided in a common semiconductor package.

In the temperature measurement method according to any of the above, the contactless type temperature measurement unit may have a quantum type infrared sensor.

In the temperature measurement method according to any of the above, the measurement target may be a living organism.

In a fifth aspect of the invention, a temperature measurement method is provided. The method includes: a step in which a first contactless type temperature measurement unit of a temperature measurement device measures a temperature of a measurement target to acquire first contactless measurement data; a step in which a second contactless type temperature measurement unit of the temperature measurement device measures the temperature of the measurement target to acquire second contactless measurement data; and a step of calculating the temperature of the measurement target based on the first contactless measurement data and the second contactless measurement data.

In a sixth aspect of the invention, a temperature measurement method is provided. The temperature measurement method includes: a step in which a contactless type temperature measurement unit of a temperature measurement device measures a temperature of a measurement target to acquire contactless measurement data; a step in which a contact detection unit of the temperature measurement device determining a contact state with the measurement target and outputting a contact detection signal; and a step of calculating the temperature of the measurement target based on the contactless measurement data and the contact detection signal.

In a seventh aspect of the invention, a temperature measurement device is provided. The temperature measurement device includes: a contactless type temperature measurement unit that measures a temperature of a measurement target to acquire contactless measurement data; a contact type temperature measurement unit that measures the temperature of the measurement target to acquire contact measurement data; and a calculation unit that calculates the temperature of the measurement target based on the contactless measurement data and the contact measurement data.

In the temperature measurement device according to any of the above, the calculation unit may calculate the temperature of the measurement target based on the temporal changes of the contactless measurement data and the contact measurement data.

In the temperature measurement device according to any of the above, the calculation unit may calculate the temperature of the measurement target based on temporal changes in a predetermined time window for temperature calculation before or until a time point at which the contactless measurement data decreases and the contact measurement data increases.

In the temperature measurement device according to any of the above, the time window for temperature calculation may be greater than 0 seconds and equal to or less than 15 seconds.

In the temperature measurement device according to any of the above, the calculation unit may calculate the temperature of the measurement target based on the maximum of the contactless measurement data in the time window for temperature calculation.

In the temperature measurement device according to any of the above, the calculation unit may calculate the temperature of the measurement target as a value of 95% or more and 110% or less of the maximum of the contactless measurement data.

In the temperature measurement device according to any of the above, the contactless type temperature measurement unit may acquire the contactless measurement data at a time interval of 0.004 seconds or more and 5 seconds or less.

The temperature measurement device according to any of the above may notify an error in a case where an amount of change of the contact measurement data acquired by the contact type temperature measurement unit does not exceed a predetermined error reference value within a predetermined error determination period.

In the temperature measurement device according to any of the above, the contactless type temperature measurement unit and the contact type temperature measurement unit may be provided in a common semiconductor package.

In the temperature measurement device according to any of the above, a distance between the contactless type temperature measurement unit and the contact type temperature measurement unit may be within 3 cm.

In the temperature measurement device according to any of the above, the contactless type temperature measurement unit may have a quantum type infrared sensor.

An eighth aspect of the invention provides a temperature measurement device including: a first contactless type temperature measurement unit that measures a temperature of a measurement target to acquire first contactless measurement data; a second contactless type temperature measurement unit that measures the temperature of the measurement target to acquire second contactless measurement data; and a calculation unit that calculates the temperature of the measurement target based on the first contactless measurement data and the second contactless measurement data.

A ninth aspect of the invention provides a temperature measurement device including: a contactless type temperature measurement unit that measures a temperature of a measurement target to acquire contactless measurement data; a contact detection unit that determines a contact state with the measurement target and outputs a contact detection signal; and a calculation unit that calculates the temperature of the measurement target based on the contactless measurement data and the contact detection signal.

A tenth aspect of the invention provides a program that, when executed by a computer, causes the computer to: control a contactless type temperature measurement unit of a temperature measurement device to measure a temperature of a measurement target to acquire contactless measurement data; control a contact type temperature measurement unit of the temperature measurement device to measure the temperature of the measurement target to acquire contact measurement data; and calculate the temperature of the measurement target based on the contact measurement data and the contactless measurement data.

An eleventh aspect of the invention provides a program that, when executed by a computer, causes the computer to: control a first contactless type temperature measurement unit of a temperature measurement device to measure a temperature of a measurement target to acquire first contactless measurement data; control a second contactless type temperature measurement unit of the temperature measurement device to measure the temperature of the measurement target to acquire second contactless measurement data; and calculate the temperature of the measurement target based on the first contactless measurement data and the second contactless measurement data.

A twelfth aspect of the invention provides a program that, when executed by a computer, causes the computer to: control a contactless type temperature measurement unit of a temperature measurement device to measure a temperature of a measurement target to acquire contactless measurement data; control a contact detection unit of the temperature measurement device to determine a contact state with the measurement target and output a contact detection signal; and calculate the temperature of the measurement target based on the contactless measurement data and the contact detection signal.

Hereinafter, the invention will be described through embodiments of the invention, but the following embodiments do not limit the invention according to the claims. Also, not all combinations of features described in the embodiments are necessarily essential to the solution of the invention.

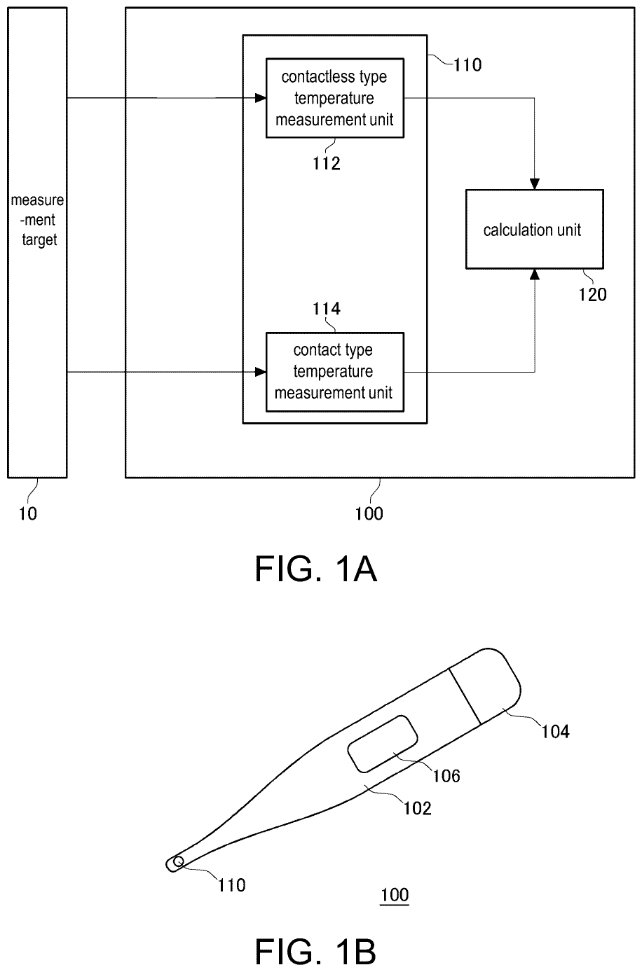

FIG. 1A illustrates an example of a configuration of a temperature measurement device 100 together with a measurement target 10. The temperature measurement device 100 includes a temperature measurement module 110 and a calculation unit 120. The temperature measurement module 110 has a contactless type temperature measurement unit 112 and a contact type temperature measurement unit 114. The illustrated blocks are functional blocks that are functionally separated respectively, and do not necessarily have to correspond to the actual device configuration. That is, a block shown as one block in the figure does not necessarily have to be configured by one device. Also, blocks illustrated as separate blocks in the figure do not necessarily have to be configured by separate devices. The same applies to blocks in other figures.

The temperature measurement device 100 measures the temperature of the measurement target 10. The measurement target 10 may be a living organism. The measurement target 10 may be a human body, may be an animal, or may be something other than a living organism such as a machine. For example, when the temperature of the measurement target 10 is higher than the ambient temperature, the temperature measurement device 100 is capable of measuring the temperature of the measurement target 10. As an example, the temperature measurement device 100 is a clinical thermometer that measures the temperature of a human body.

The contactless type temperature measurement unit 112 measures the temperature of the measurement target 10 and acquires contactless measurement data. The contactless type temperature measurement unit 112 may be able to measure the temperature of the measurement target 10 in a state of not contacting the measurement target 10. For example, the contactless type temperature measurement unit 112 has a radiation thermometer that measures a temperature based on the radiation from the measurement target 10. As an example, the contactless type temperature measurement unit 112 has a quantum type infrared sensor. As another example, the contactless type temperature measurement unit 112 has a thermopile type infrared sensor.

The contactless measurement data acquired by the contactless type temperature measurement unit 112 is not limited to the measurement data acquired in a state where the contactless type temperature measurement unit 112 does not contact the measurement target 10. The contactless measurement data may include the measurement data acquired in a state where the contactless type temperature measurement unit 112 contacts the measurement target 10. For example, in the case where the contactless type temperature measurement unit 112 has a radiation thermometer, the contactless type temperature measurement unit 112 is able to measure the temperature based on the radiation from the measurement target 10 even in a state of contacting the measurement target 10.

The contact type temperature measurement unit 114 measures the temperature of the measurement target 10 and acquires the contact measurement data. The contact type temperature measurement unit 114 may be able to measure the temperature of the measurement target 10 in a state of being in contact with the measurement target 10. For example, the contact type temperature measurement unit 114 may have a thermal resistance thermometer that measures a temperature based on an electrical resistance change due to a temperature change, and may have a thermoelectromotive force thermometer that measures the temperature based on the thermoelectromotive force due to a temperature difference. As an example, the contact type temperature measurement unit 114 has a platinum resistor, a thermocouple, or a thermistor.

The calculation unit 120 calculates the temperature of the measurement target 10 based on the contactless measurement data and the contact measurement data. Details of the temperature calculation method for the measurement target 10 as performed by the calculation unit 120 will be described later.

FIG. 1B illustrates an example of the temperature measurement device 100. For example, the measurement target 10 is a human body, and the temperature measurement device 100 is a clinical thermometer that measures the temperature of the human body.

The temperature measurement device 100 may include a main body part 102, a cover part 104, and a display unit 106. Inside the main body part 102, for example, an arithmetic circuit is provided, and the arithmetic circuit may be accommodated by the main body part 102 and the cover part 104. The temperature measurement module 110 may be provided in the vicinity of the tip on the side of the main body part 102 opposite to the cover part 104. The temperature measurement module 110 may be controlled by the arithmetic circuit built in the main body part 102. The calculation unit 120 may be realized by an arithmetic circuit built in the main body part 102. The display unit 106 may display the temperature of the measurement target 10 calculated by the calculation unit 120.

The temperature measurement device 100 may measure the temperature of the measurement target 10 in a process of transitioning from a state where the temperature measurement device 100 does not contact the measurement target 10 to a state where the temperature measurement device 100 contacts the measurement target 10. More specifically, the temperature measurement device 100 may measure the temperature of the measurement target 10 in a process of transitioning from a state where the vicinity of the tip where the temperature measurement module 110 is provided does not contact the measurement target 10 to a state where the tip contacts the measurement target 10. For example, the temperature measurement device 100 measures the temperature of the measurement target 10 in a process of transitioning from a state where the tip thereof is not held under the armpit of the human body to a state where the tip approaches the armpit and is held under the armpit. However, the body part that the temperature measurement device 100 measures is not limited to the armpit.

The temperature measurement device 100 may notify that the temperature measurement of the measurement target 10 has been completed. The temperature measurement device 100 may notify with a sound that the temperature measurement of the measurement target 10 has been completed, and may notify by displaying on the display unit 106, or may notify by vibration.

The temperature measurement device 100 may notify an error in the case where the amount of change in the contact measurement data acquired by the contact type temperature measurement unit 114 does not exceed a predetermined error reference value within a predetermined error determination period. The temperature measurement device 100 may notify the error with a sound, may notify by displaying on the display unit 106, or may notify by vibration. The error determination period may be 20 seconds or more and 40 seconds or less. The error reference value may be 0.1° C. or more and 0.3° C. or less. For example, the temperature measurement device 100 notifies an error in the case where the amount of change in the contact measurement data is 0.2° C. or less during 30 seconds.

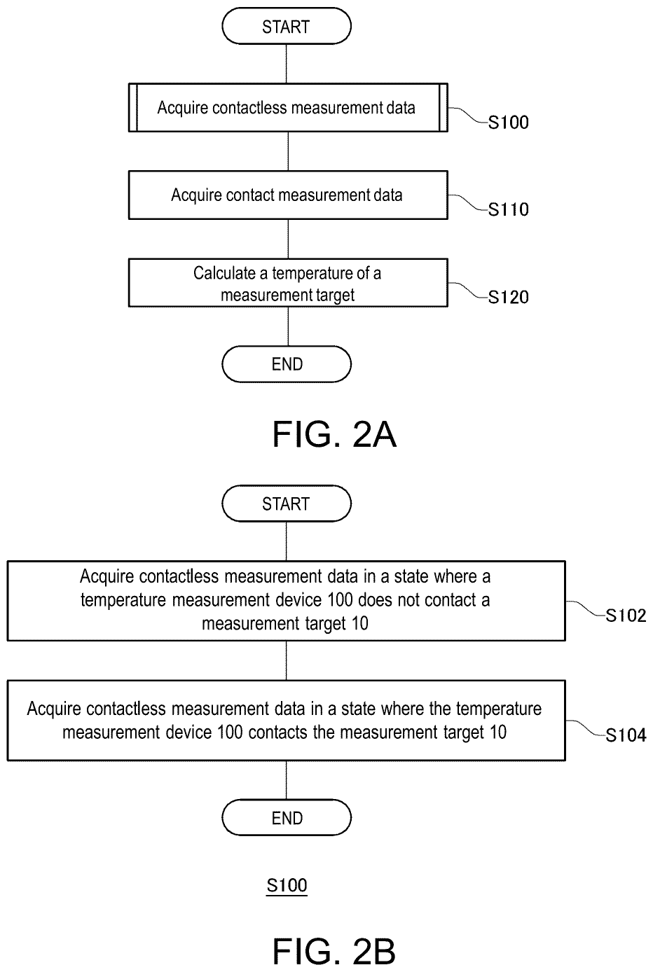

FIG. 2A illustrates an example of the temperature measurement method. The temperature measurement method of this example is a temperature measurement method using the temperature measurement device 100 including the contactless type temperature measurement unit 112 and the contact type temperature measurement unit 114. For example, the temperature measurement method is a method for measuring the temperature of a human body, but the invention is not limited thereto.

In Step S100, the contactless type temperature measurement unit 112 of the temperature measurement device 100 measures the temperature of the measurement target 10 to acquire the contactless measurement data. In Step S110, the contact type temperature measurement unit 114 of the temperature measurement device 100 measures the temperature of the measurement target 10 to acquire the contact measurement data. From Step S100 to Step S110, the temperature measurement device 100 may transition from a state of not contacting the measurement target 10 to a state of contacting the measurement target 10.

In Step S120, the temperature of the measurement target 10 is calculated based on the contactless measurement data and the contact measurement data. Details of the temperature calculation will be described later.

FIG. 2B illustrates an example of Step S100 of acquiring the contactless measurement data. Step S100 of acquiring the contactless measurement data may include Step S102 of acquiring the contactless measurement data in a state where the temperature measurement device 100 is not in contact with the measurement target 10. Step S100 of acquiring the contactless measurement data may include Step S104 of acquiring the contactless measurement data in a state where the temperature measurement device 100 is in contact with the measurement target 10. That is, in Step S100 where the contactless type temperature measurement unit 112 of the temperature measurement device 100 measures the temperature of the measurement target 10 to acquire the contactless measurement data, the temperature measurement device 100 may be in a state of not contacting the measurement target 10, or may be in a state of contacting the measurement target 10.

As described above, from Step S100 to Step S110, the temperature measurement device 100 may transition from a state of not contacting the measurement target 10 to a state of contacting the measurement target 10. Accordingly, Step S100 of acquiring the contactless measurement data may include Step S102 of acquiring the contactless measurement data in the state where the temperature measurement device 100 is not in contact with the measurement target 10 and Step S104 of acquiring the contactless measurement data in the state where the temperature measurement device 100 is in contact with the measurement target 10, in the process where the temperature measurement device 100 transitions from the state of not contacting the measurement target 10 to the state of contacting the measurement target 10.

The temperature measurement method may include a step of notifying that the temperature measurement of the measurement target 10 is completed. The temperature measurement method may include a step of notifying an error in the case where the amount of change in the contact measurement data acquired by the contact type temperature measurement unit 114 does not exceed a predetermined error reference value within a predetermined error determination period. The notification method, the error determination period, and the error reference value are as described above.

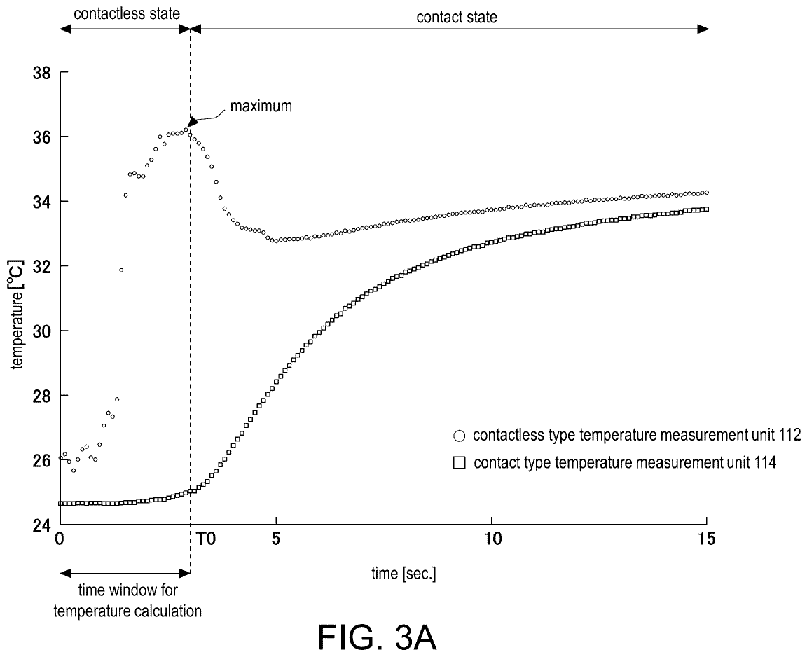

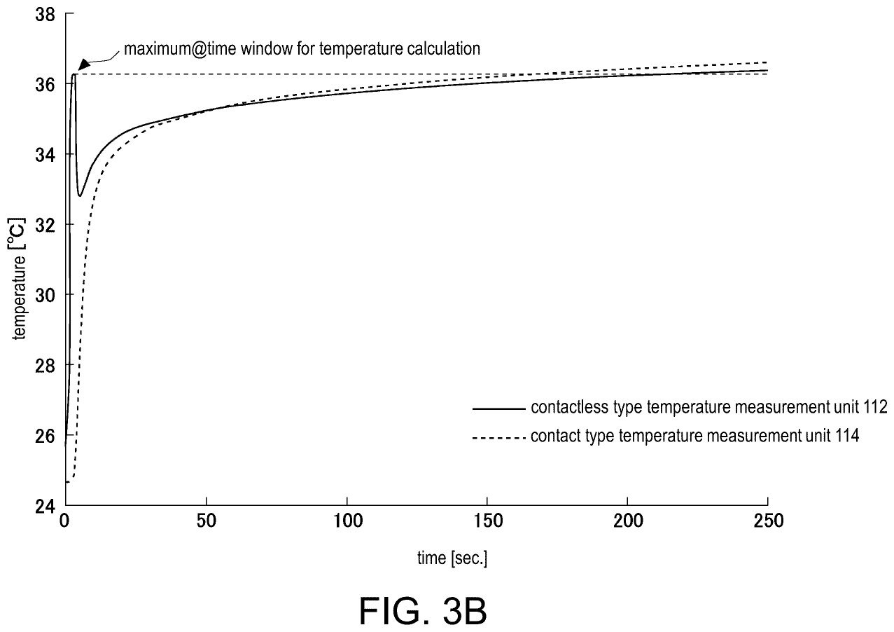

FIG. 3A illustrates an example of temporal changes of measurement data. In this figure, the horizontal axis represents time, and the vertical axis represents temperature acquired as measurement data. White circles represent temperatures acquired by the contactless type temperature measurement unit 112 as the contactless measurement data, and white squares represent temperatures acquired by the contact type temperature measurement unit 114 as the contact measurement data. The period before a time point T0 indicates a state where the temperature measurement device 100 is not in contact with the measurement target 10, and the period after time point T0 indicates a state where the temperature measurement device 100 is in contact with the measurement target 10.

Step S120 of calculating the temperature of the measurement target 10 may include a step of calculating the temperature of the measurement target 10 based on the temporal changes of the contactless measurement data and the contact measurement data. That is, the calculation unit 120 may calculate the temperature of the measurement target 10 based on the temporal changes of the contactless measurement data and the contact measurement data. The calculation unit 120 calculates the temperature of the measurement target 10 based on, for example, the temporal changes of the measurement data as illustrated in FIG. 3A.

Step S120 of calculating the temperature of the measurement target 10 may include a step of calculating the temperature of the measurement target 10 based on the temporal changes in a predetermined time window for temperature calculation before or until a time point at which the contactless measurement data decreases and the contact measurement data increases. That is, the calculation unit 120 may calculate the temperature of the measurement target 10 based on the temporal changes in a predetermined time window for temperature calculation before or until a time point at which the contactless measurement data decreases and the contact measurement data increases. For example, the time point at which the contactless measurement data decreases and the contact measurement data increases may be the time point T0.

The time window for temperature calculation may be greater than 0 seconds and equal to or less than 15 seconds. The time window for temperature calculation in this example is approximately 3 seconds. However, the invention is not limited thereto. The time window for temperature calculation may be a period before or until the time point T0 at which the contactless measurement data decreases and the contact measurement data increases, and may be a period in which a peak exists in the temporal changes of the contactless measurement data.

Step S120 of calculating the temperature of the measurement target 10 may include a step of calculating the temperature of the measurement target 10 based on either the maximum or the minimum of the contactless measurement data during the time window for temperature calculation. That is, the calculation unit 120 may calculate the temperature of the measurement target 10 based on either the maximum or the minimum of the contactless measurement data during the time window for temperature calculation. However, the calculation unit 120 may calculate the temperature of the measurement target 10 based on other contactless measurement data during the time window for temperature calculation. The contactless measurement data used by the calculation unit 120 to calculate the temperature of the measurement target 10 may be contactless measurement data before and after a time point at which either the maximum or the minimum is measured. For example, the calculation unit 120 may calculate the temperature of the measurement target 10 based on a value of 90% of either the maximum value or the minimum of the contactless measurement data during the time window for temperature calculation.

Step S120 of calculating the temperature of the measurement target 10 may include a step of calculating the temperature of the measurement target 10 as a value of 95% or more and 110% or less of either the maximum or the minimum of the contactless measurement data. That is, the calculation unit 120 may calculate the temperature of the measurement target 10 as a value of 95% or more and 110% or less of either the maximum or the minimum of the contactless measurement data. The calculation unit 120 may determine as what percentage of either the maximum or the minimum of the contactless measurement data the temperature of the measurement target 10 is calculated, based on the ambient temperature. The calculation unit 120 may determine as what percentage of either the maximum or the minimum of the contactless measurement data the temperature of the measurement target 10 is calculated, based on humidity of the environment. The calculation unit 120 may determine as what percentage of either the maximum or the minimum of the contactless measurement data the temperature of the measurement target 10 is calculated, based on the contact measurement data before or until the time point T0 at which the contactless measurement data decreases and the contact measurement data increases. The calculation unit 120 may determine as what percentage of either the maximum or the minimum of the contactless measurement data the temperature of the measurement target 10 is calculated, based on the contact measurement data after the time point T0 at which the contactless measurement data decreases and the contact measurement data increases.

The contactless measurement data during the time window for temperature calculation in this example has the maximum. For example, in the case where the temperature of the measurement target 10 is higher than the temperature of the temperature measurement device 100, the contactless measurement data has the maximum during the time window for temperature calculation. Accordingly, Step S120 of calculating the temperature of the measurement target 10 may include a step of calculating the temperature of the measurement target 10 based on the maximum of the contactless measurement data during the time window for temperature calculation, and the calculation unit 120 may calculate the temperature of the measurement target 10 based on the maximum of the contactless measurement data during the time window for temperature calculation.

As another example, in the case where the temperature of the measurement target 10 is lower than the temperature of the temperature measurement device 100, the contactless measurement data has the minimum during the time window for temperature calculation. Accordingly, Step S120 of calculating the temperature of the measurement target 10 may include a step of calculating the temperature of the measurement target 10 based on the minimum of the contactless measurement data during the time window for temperature calculation, and the calculation unit 120 may calculate the temperature of the measurement target 10 based on the minimum of the contactless measurement data during the time window for temperature calculation.

Step S100 of acquiring the contactless measurement data may include a step of acquiring the contactless measurement data at a time interval of 0.004 seconds or more and 5 seconds or less. That is, the contactless type temperature measurement unit 112 may acquire the contactless measurement data at a time interval of 0.004 seconds or more and 5 seconds or less. 0.004 seconds is, for example, a minimum time interval at which a quantum type infrared sensor is capable of performing a measurement. In the case where the time interval is longer than 5 seconds, there is a possibility that the peak in the temporal changes of the contactless measurement data cannot be accurately detected.

The contactless type temperature measurement unit 112 may acquire the contactless measurement data at a time interval of 0.02 seconds or more and 1 second or less. For example, in the case where the time interval is 0.02 seconds, the power consumption for driving the contactless type temperature measurement unit 112 increases, but the peak in the temporal changes of the contactless measurement data can be accurately detected. In the case where the time interval is 1 second, the power consumption for driving the contactless type temperature measurement unit 112 can be reduced. The contactless type temperature measurement unit 112 may acquire the contactless measurement data at a time interval of 0.1 seconds or more and 0.5 seconds or less. This enables improvement of measurement accuracy while reducing the power consumption for driving the contactless type temperature measurement unit 112. The contactless type temperature measurement unit 112 in this example acquires the contactless measurement data at a time interval of 0.1 seconds.

FIG. 3B illustrates an example of the temporal changes of the measurement data over a longer period including the measurement period of FIG. 3A. In this figure, a solid line represents the temperature acquired by the contactless type temperature measurement unit 112 as the contactless measurement data, and a dashed line represents the temperature acquired by the contact type temperature measurement unit 114 as the contact measurement data. In this figure, depiction of each measurement value acquired by each measurement unit at a predetermined time interval is omitted, and the measurement data is depicted as continuous line segments.

When a sufficiently long time has elapsed since the temperature measurement device 100 contacts the measurement target 10, the temperature measurement device 100 and the measurement target 10 reach a thermal equilibrium state, and the measurement data asymptotically approaches the temperature of the measurement target 10. Referring to the time point of 250-second in FIG. 3B, the maximum of the contactless measurement data in the time window for temperature calculation before or until the time point T0 at which the contactless measurement data decreases and the contact measurement data increases substantially coincides with the measurement data that asymptotically approaches the temperature of the measurement target 10. Therefore, by calculating the temperature of the measurement target 10 based on the maximum of the contactless measurement data in the time window for temperature calculation, an accurate temperature can be calculated.

For example, in the case where the contactless type temperature measurement unit 112 has a radiation thermometer that measures the temperature based on the radiation from the measurement target 10, the contactless type temperature measurement unit 112 measures the temperature based on the radiation within the field of view of the contactless type temperature measurement unit 112. In the case where radiation from radiation sources other than the measurement target 10 is included within the field of view of the contactless type temperature measurement unit 112, the measured temperature may include the influence of the temperature of such radiation sources. Therefore, with the field of view of the contactless type temperature measurement unit 112 being covered with the measurement target 10, a more accurate measurement becomes possible.

When the temperature measurement device 100 contacts the measurement target 10, the contactless measurement data decreases, and the contact measurement data increases. For example, in the case where the contactless type temperature measurement unit 112 has a radiation thermometer that measures the temperature based on the radiation from the measurement target 10, the radiation sensor that detects radiation from the measurement target 10 outputs a current corresponding to the difference between the temperature of the measurement target 10 and the temperature of the radiation sensor. The radiation thermometer estimates the temperature based on the magnitude of the current output by the radiation sensor and the temperature of the built-in thermometer. When the temperature measurement device 100 contacts the measurement target 10, the temperature of the radiation sensor close to the surface of the temperature measurement device 100 may become higher than the temperature of the built-in thermometer first. In this case, the amount of the current output by the radiation sensor becomes small. However, the built-in thermometer is lower than the temperature of the radiation sensor, so, as a result, the radiation thermometer may output a temperature lower than the actual temperature.

Based on the above operation, the time point T0 at which the contactless measurement data decreases and the contact measurement data increases has a high probability of being the time point at which the temperature measurement device 100 contacts the measurement target 10. In other words, in the vicinity of the time point T0, there is a high probability that the field of view of the contactless type temperature measurement unit 112 is covered with the measurement target 10. Therefore, by calculating the temperature of the measurement target 10 based on the temporal changes in a predetermined time window for temperature calculation before or until the time point at which the contactless measurement data decreases and the contact measurement data increases, the temperature of the measurement target 10 can be accurately calculated. However, the method for determining the time point at which there is a high probability that the temperature measurement device 100 has contacted the measurement target 10 or the time point at which there is a high probability that the field of view of the contactless type temperature measurement unit 112 is covered with the measurement target 10 is not limited. The temperature measurement device 100 may make such a determination by any appropriate method using the contactless measurement data and the contact measurement data.

In the above, the operation in the case where the temperature of the measurement target 10 is higher than the temperature of the temperature measurement device 100 is described, but as described above, in the case where the temperature of the measurement target 10 is lower than the temperature of the temperature measurement device 100, the minimum may be used instead of the maximum. Also, in this case, the trends (increase or decrease) of the contactless measurement data and the contact measurement data may also be reversed.

As described above, the temperature measurement method and the temperature measurement device 100 of this example calculate the temperature of the measurement target 10 based on the contactless measurement data and the contact measurement data. Accordingly, the temperature of the measurement target 10 can be calculated accurately.

In the case where the temperature of the measurement target 10 is calculated based on the contact measurement data only, time is required until the transfer of heat between the temperature measurement device and the measurement target 10 sufficiently progresses, and time may be required until the temperature of the measurement target 10 is calculated. Since the temperature measurement method and the temperature measurement device 100 of this example calculate the temperature of the measurement target 10 based on the contactless measurement data and the contact measurement data, the temperature of the measurement target 10 can be accurately calculated in a shorter time than the case where the temperature of the measurement target 10 is calculated based only on the contact measurement data. That is, in the temperature measurement method and the temperature measurement device 100 of this example, since the contact measurement data is used for determining the time point of contact between the temperature measurement device 100 and the measurement target 10, there is no need to wait until the transfer of heat sufficiently progresses.

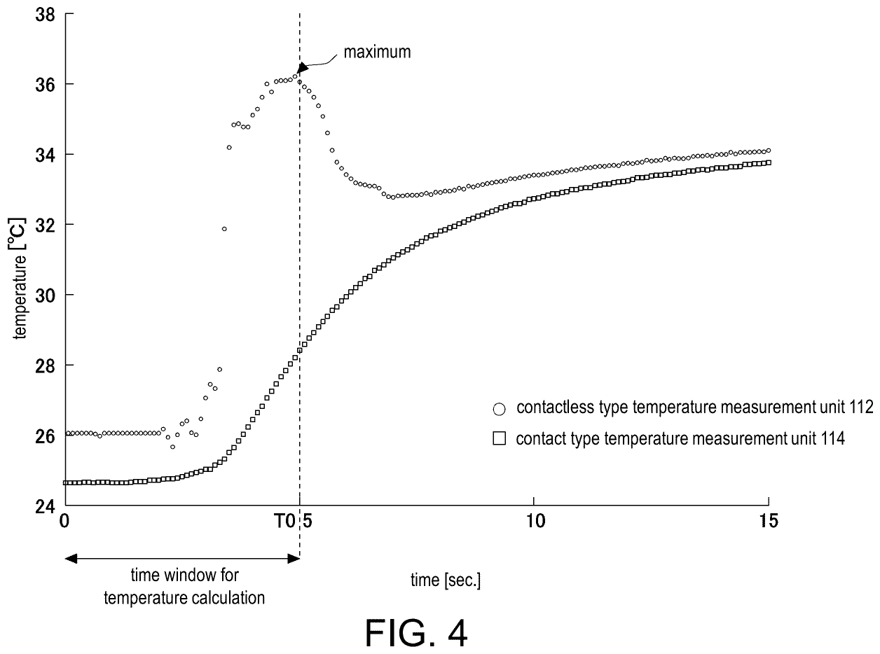

FIG. 4 illustrates an example of the temporal changes of the measurement data. The temporal changes of this example differ from the example of FIG. 3A in that a deviation occurs between the time point at which the contact measurement data starts to increase and the time point at which the contactless measurement data starts to decrease. For example, in the case where the temperature measurement device 100 is brought into contact with the measurement target 10, if heat conduction occurs in the contact type temperature measurement unit 114 before the contactless type temperature measurement unit 112, a timing deviation as shown in FIG. 4 may occur. Alternatively, a timing deviation as shown in FIG. 4 may occur due to a deviation of the temperature measurement device 100 or the like while the temperature measurement device 100 is in contact with the measurement target 10.

Also in this case, Step S120 of calculating the temperature of the measurement target 10 may have a step of calculating the temperature of the measurement target 10 based on the temporal changes in the predetermined time window for temperature calculation before or until the time point at which the contactless measurement data decreases and the contact measurement data increases. That is, the calculation unit 120 may calculate the temperature of the measurement target 10 based on the temporal changes in the predetermined time window for temperature calculation before or until the time point at which the contactless measurement data decreases and the contact measurement data increases. As described in relation to FIG. 3A, there is a high probability that the time point T0 at which the contactless measurement data decreases and the contact measurement data increases is the time point at which the temperature measurement device 100 contacts the measurement target 10.

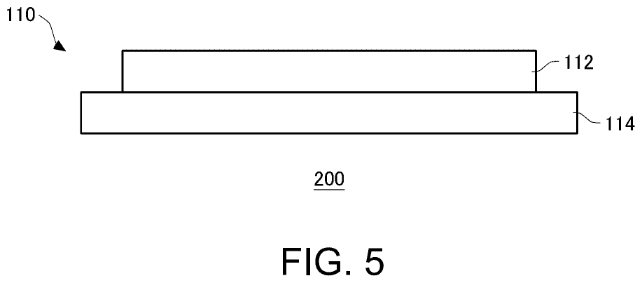

FIG. 5 illustrates an example of a semiconductor package 200. The semiconductor package 200 is an example of the temperature measurement module 110. The semiconductor package 200 may have the contactless type temperature measurement unit 112 and the contact type temperature measurement unit 114. That is, the contactless type temperature measurement unit 112 and the contact type temperature measurement unit 114 may be provided in the common semiconductor package 200.

For example, the contactless type temperature measurement unit 112 has a radiation thermometer that measures a temperature based on the radiation from the measurement target 10. The contact type temperature measurement unit 114 may have a large-scale integrated circuit capable of measuring the temperature by contacting the measurement target 10. That is, the semiconductor package 200 may be configured by providing a radiation sensor above a large-scale integrated circuit capable of measuring the temperature by contacting the measurement target 10.

The radiation thermometer that the contactless type temperature measurement unit 112 has may measure the temperature of the measurement target 10 based on the radiation from the measurement target 10 and the temperature that the contact type temperature measurement unit 114 measures. That is, the contact type temperature measurement unit 114 may serve as a built-in thermometer of the contactless type temperature measurement unit 112. In this way, the contactless type temperature measurement unit 112 and the contact type temperature measurement unit 114 may be provided in the common semiconductor package 200, and the contact type temperature measurement unit 114 may serve as a built-in thermometer of the contactless type temperature measurement unit 112.

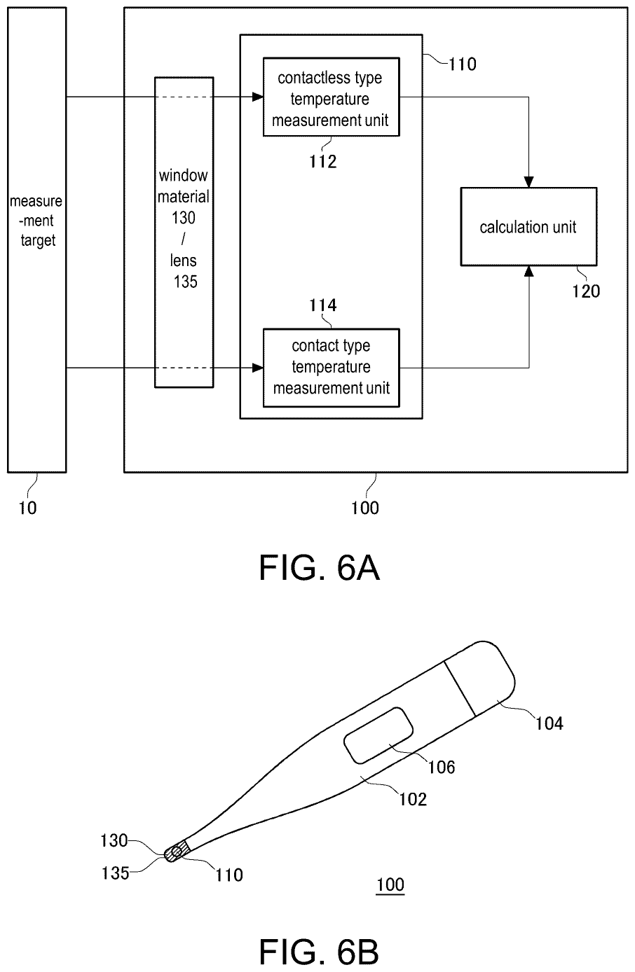

FIG. 6A illustrates a modified example of the configuration of the temperature measurement device 100 together with the measurement target 10. The temperature measurement device 100 of this example differs from the embodiment of FIG. 1A in that the temperature measurement device 100 includes a window material 130 or a lens 135. Others may be the same as the embodiment of FIG. 1A.

The contactless type temperature measurement unit 112 may measure the temperature of the measurement target 10 through the window material 130 or the lens 135 to acquire the contactless measurement data. The contact type temperature measurement unit 114 may measure the temperature of the measurement target 10 through the window material 130 or the lens 135 to acquire the contact measurement data.

The window material 130 may be a member that transmits at least a portion of a predetermined wavelength band. As an example, the window material 130 is a member that transmits at least a portion of a wavelength band from 4 μm to 10 μm. The window material 130 may be, for example, an optical filter. For example, the material of the window material 130 may be any of silicon, germanium, sapphire, diamond, calcium fluoride, barium fluoride, potassium bromide, zinc selenide, zinc sulfide, chalcogenide glass, or quartz.

The lens 135 may be a Fresnel lens or a spherical lens. The lens 135 may include a function of transmitting at least a portion of a predetermined wavelength band. The window material 130 and the lens 135 may be the same part, may be multiple parts integrated, and may be present as separate bodies.

FIG. 6B illustrates a modified example of the temperature measurement device 100. The temperature measurement device 100 of this example is an example of a temperature measurement device that embodies the configuration of FIG. 6A. The window material 130 or the lens 135 may be provided so as to cover the temperature measurement module 110 in the vicinity of the tip of the main body part 102 where the temperature measurement module 110 is provided. The window material 130 may protect the temperature measurement module 110 from dirt or dust and the like. The lens 135 may focus the radiation from the measurement target 10 onto the contactless type temperature measurement unit 112.

In the case where the temperature measurement module 110 is covered by the window material 130, the radiation quantity observed by the contactless type temperature measurement unit 112 is reduced, and the contactless measurement data may change. Also, in the case where the temperature measurement module 110 is covered by the window material 130, the heat conduction properties from the measurement target 10 may change, and the contact measurement data may change. The calculation unit 120 may determine as what percentage of either the maximum or the minimum of the contactless measurement data the temperature of the measurement target 10 is calculated, based on at least one of the material of the window material 130, the thickness of the window material 130, the refractive index of the window material 130, the transmittance of the window material 130, or the thermal conductivity of the window material 130. Similarly, the calculation unit 120 may determine as what percentage of either the maximum or the minimum of the contactless measurement data the temperature of the measurement target 10 is calculated, based on at least one of the material of the lens 135, the shape of the lens 135, the refractive index of the lens 135, the transmittance of the lens 135, or the thermal conductivity of the lens 135.

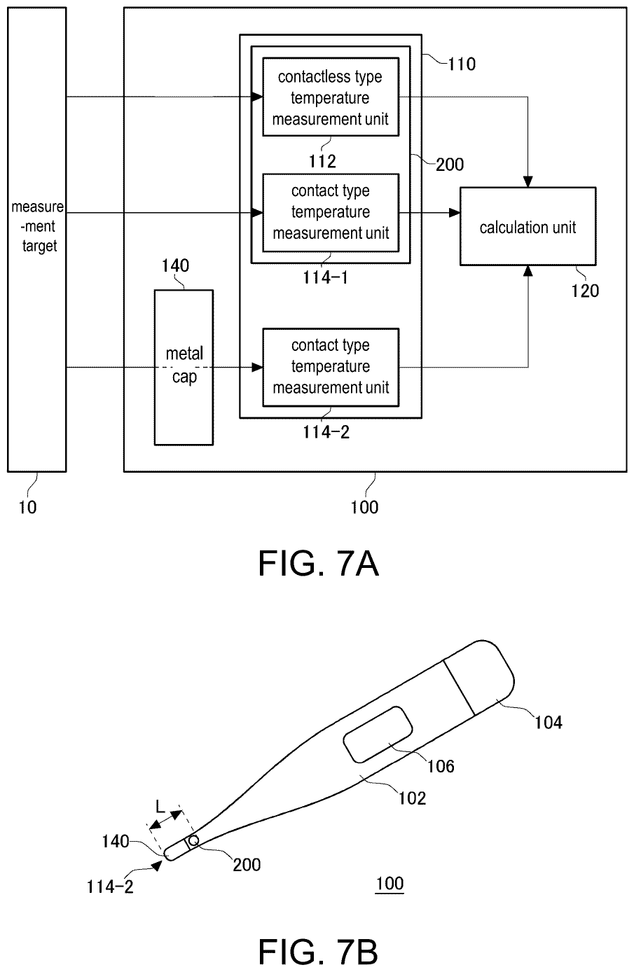

FIG. 7A illustrates a modified example of the configuration of the temperature measurement device 100 together with the measurement target 10. The temperature measurement device 100 of this example differs from the embodiment of FIG. 1A in that it includes multiple contact type temperature measurement units 114. Other aspects may be the same as the embodiment of FIG. 1A.

The temperature measurement device 100 may include the contactless type temperature measurement unit 112 and a contact type temperature measurement unit 114-1 provided in the common semiconductor package 200, as well as a contact type temperature measurement unit 114-2 provided separately from the semiconductor package 200. The contact type temperature measurement unit 114-2 may measure the temperature of the measurement target 10 through a metal cap 140 to acquire the contact measurement data. For example, the contact type temperature measurement unit 114-2 has a platinum resistance.

FIG. 7B illustrates a modified example of the temperature measurement device 100. The temperature measurement device 100 of this example is an example of a temperature measurement device that embodies the configuration of FIG. 7A.

The contact type temperature measurement unit 114-2 may be provided in the vicinity of the tip of the main body part 102. The semiconductor package 200 may be provided closer to the center side of the main body part 102 than the contact type temperature measurement unit 114-2 in the vicinity of the tip of the main body part 102. In this way, the temperature measurement device 100 of this example may be realized by adding the semiconductor package 200 to an existing temperature measurement device that does not include the semiconductor package 200 and includes only the contact type temperature measurement unit 114-2.

The distance between the contactless type temperature measurement unit 112 and the contact type temperature measurement unit 114 may be within 5 cm, and may be within 3 cm. The distance between the contactless type temperature measurement unit 112 and the contact type temperature measurement unit 114 may be a distance L between the most separated parts of the contactless type temperature measurement unit 112 and the contact type temperature measurement unit 114. That is, in FIG. 7B, L may be within 5 cm, and may be within 3 cm. Accordingly, since the position of the measurement target 10 that the contactless type temperature measurement unit 112 measures and the position of the measurement target 10 that the contact type temperature measurement unit 114 measures become substantially the same, the temperature of the measurement target 10 can be accurately calculated. The contactless type temperature measurement unit 112 and the contact type temperature measurement unit 114 may be located within 5 cm or within 3 cm by being provided in the common semiconductor package 200 like the contactless type temperature measurement unit 112 and the contact type temperature measurement unit 114-1, and may be located within 5 cm or within 3 cm while being provided separately like the contactless type temperature measurement unit 112 and the contact type temperature measurement unit 114-2.

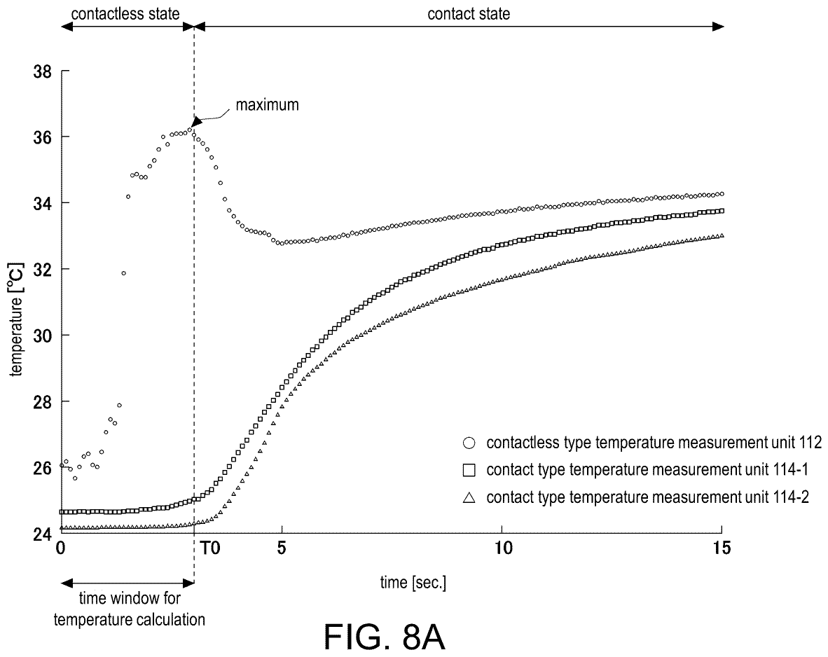

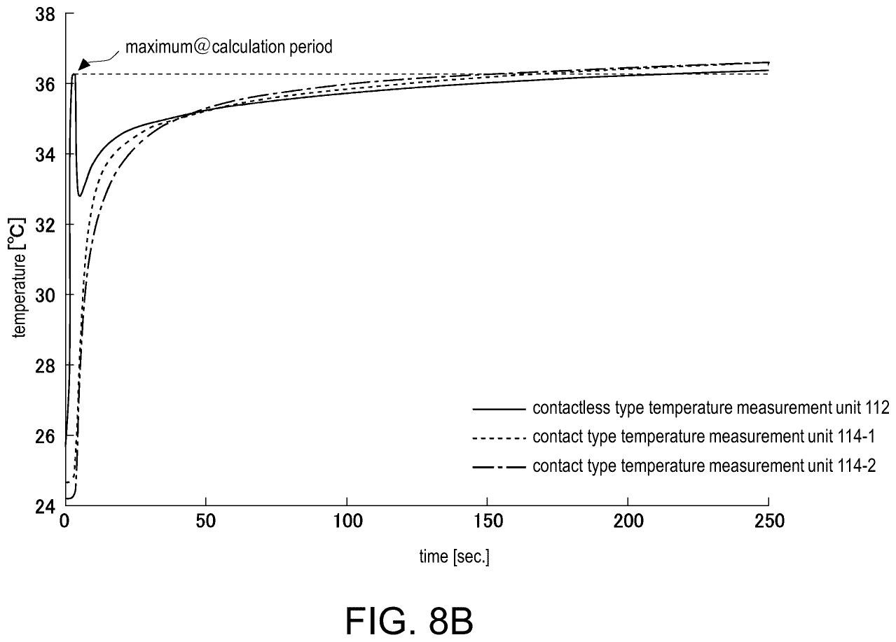

FIG. 8A illustrates an example of temporal changes of measurement data. In this figure, the horizontal axis represents time, and the vertical axis represents temperature acquired as measurement data. White circles represent temperatures acquired by the contactless type temperature measurement unit 112 as the contactless measurement data, white squares represent temperatures acquired by the contact type temperature measurement unit 114-1 as the contact measurement data, and white triangles represent temperatures acquired by the contact type temperature measurement unit 114-2 as the contact measurement data. The period before or until the time point T0 indicates a state in which the temperature measurement device 100 does not contact the measurement target 10, and the period after the time point T0 indicates a state in which the temperature measurement device 100 contacts the measurement target 10.

Step S120 of calculating the temperature of the measurement target 10 may include a ste of calculating the temperature of the measurement target 10 based on the temporal changes of the contactless measurement data and the contact measurement data. That is, the calculation unit 120 may calculate the temperature of the measurement target 10 based on the temporal changes of the contactless measurement data and the contact measurement data. Here, the calculation unit 120 may use, as the contact measurement data, at least one of the contact measurement data acquired by the contact type temperature measurement unit 114-1 or the contact measurement data acquired by the contact type temperature measurement unit 114-2.

Step S120 of calculating the temperature of the measurement target 10 may include a ste of calculating the temperature of the measurement target 10 based on the temporal changes in the predetermined time window for temperature calculation before or until the time point at which the contactless measurement data decreases and the contact measurement data increases. That is, the calculation unit 120 may calculate the temperature of the measurement target 10 based on the temporal changes in the predetermined time window for temperature calculation before or until the time point at which the contactless measurement data decreases and the contact measurement data increases. The time window for temperature calculation may be greater than 0 seconds and equal to or less than 15 seconds.

In the case where the calculation unit 120 uses the contact measurement data acquired by the contact type temperature measurement unit 114-1 as the contact measurement data, the calculation unit 120 may calculate the temperature of the measurement target 10 based on the temporal changes in the predetermined time window for temperature calculation before or until the time point at which the contactless measurement data decreases and the contact measurement data acquired by the contact type temperature measurement unit 114-1 increases. In the case where the calculation unit 120 uses the contact measurement data acquired by the contact type temperature measurement unit 114-2 as the contact measurement data, the calculation unit 120 may calculate the temperature of the measurement target 10 based on the temporal changes in the predetermined time window for temperature calculation before or until the time point at which the contactless measurement data decreases and the contact measurement data acquired by the contact type temperature measurement unit 114-2 increases. In the case where the calculation unit 120 uses both of the contact measurement data acquired by the contact type temperature measurement unit 114-1 and the contact measurement data acquired by the contact type temperature measurement unit 114-2 as the contact measurement data, the calculation unit 120 may calculate the temperature of the measurement target 10 based on the temporal changes in the predetermined time window for temperature calculation before the earlier of the time point at which the contactless measurement data decreases and the contact measurement data acquired by the contact type temperature measurement unit 114-1 increases, or the time point at which the contactless measurement data decreases and the contact measurement data acquired by the contact type temperature measurement unit 114-2 increases.

Step S120 of calculating the temperature of the measurement target 10 may include a ste of calculating the temperature of the measurement target 10 based on either the maximum or the minimum of the contactless measurement data during the time window for temperature calculation. That is, the calculation unit 120 may calculate the temperature of the measurement target 10 based on either the maximum or the minimum of the contactless measurement data during the time window for temperature calculation.

Step S120 of calculating the temperature of the measurement target 10 may include a ste of calculating the temperature of the measurement target 10 as a value of 95% or more and 110% or less of either the maximum or the minimum of the contactless measurement data. That is, the calculation unit 120 may calculate the temperature of the measurement target 10 as a value of 95% or more and 110% or less of either the maximum or the minimum of the contactless measurement data.

The calculation unit 120 may determine as what percentage of either the maximum or the minimum of the contactless measurement data the temperature of the measurement target 10 is calculated, based on the ambient temperature. The calculation unit 120 may determine as what percentage of either the maximum or the minimum of the contactless measurement data the temperature of the measurement target 10 is calculated, based on the contact measurement data acquired by the contact type temperature measurement unit 114-1 or the contact measurement data acquired by the contact type temperature measurement unit 114-2 before or until the time point T0 at which the contactless measurement data decreases and the contact measurement data increases. The calculation unit 120 may determine as what percentage of either the maximum or the minimum of the contactless measurement data the temperature of the measurement target 10 is calculated, based on the contact measurement data acquired by the contact type temperature measurement unit 114-1 or the contact measurement data acquired by the contact type temperature measurement unit 114-2 after the time point T0 at which the contactless measurement data decreases and the contact measurement data increases.

Step S100 of acquiring the contactless measurement data may include a step of acquiring the contactless measurement data at a time interval of 0.004 seconds or more and 5 seconds or less. That is, the contactless type temperature measurement unit 112 may acquire the contactless measurement data at a time interval of 0.004 seconds or more and 5 seconds or less.

FIG. 8B illustrates an example of the temporal changes of the measurement data over a longer period including the measurement period of FIG. 8A. In this figure, a solid line represents the temperature acquired by the contactless type temperature measurement unit 112 as the contactless measurement data, a dashed line represents the temperature acquired by the contact type temperature measurement unit 114-1 as the contact measurement data, and a dashed-dotted line represents the temperature acquired by the contact type temperature measurement unit 114-2 as the contact measurement data. In this figure, the drawing of each measurement value acquired by each measurement unit at a predetermined time interval is omitted, and the measurement data is drawn as continuous line segments.

In this example as well, similar to the example of FIG. 3B, the maximum of the contactless measurement data in the time window for temperature calculation before or until the time point T0 at which the contactless measurement data decreases and the contact measurement data increases substantially coincides with the measurement data that asymptotically approaches the temperature of the measurement target 10. Therefore, an accurate temperature can be calculated by calculating the temperature of the measurement target 10 based on the maximum of the contactless measurement data in the time window for temperature calculation. That is, since the temperature measurement method and the temperature measurement device 100 of this example calculate the temperature of the measurement target 10 based on the contactless measurement data and the contact measurement data, the temperature of the measurement target 10 can be accurately calculated. In addition, since the temperature measurement method and the temperature measurement device 100 of this example calculate the temperature of the measurement target 10 based on the contactless measurement data and the contact measurement data, the temperature of the measurement target 10 can be accurately calculated in a shorter time than the case where the temperature of the measurement target 10 is calculated based on only the contact measurement data.

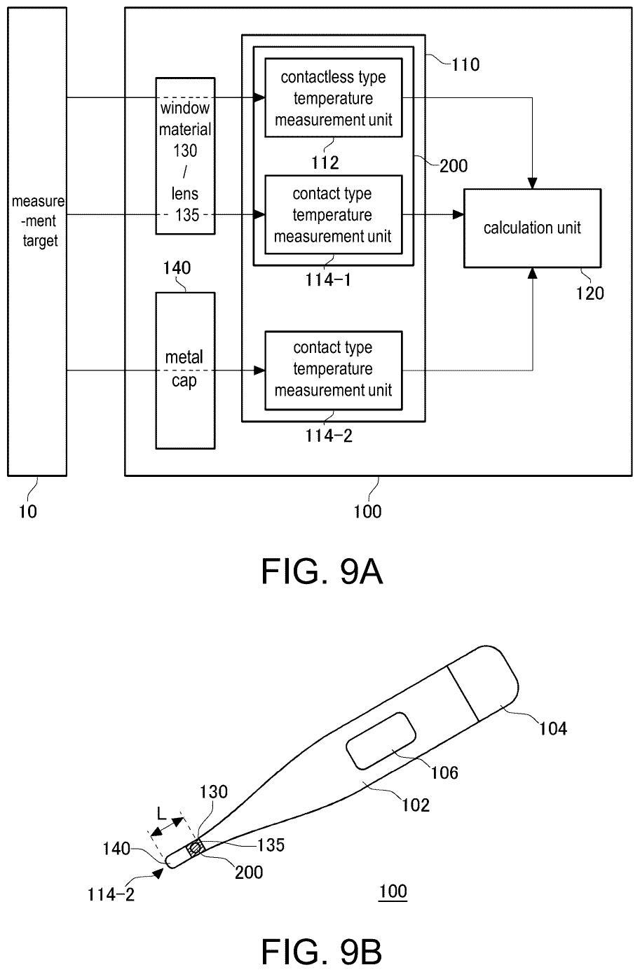

FIG. 9A illustrates a modified example of a configuration of the temperature measurement device 100 together with the measurement target 10. The temperature measurement device 100 of this example differs from the embodiment of FIG. 7A in that the temperature measurement device 100 includes the window material 130 or the lens 135. Other aspects may be the same as those of the embodiment of FIG. 7A.

The contactless type temperature measurement unit 112 may measure the temperature of the measurement target 10 through the window material 130 or the lens 135 to acquire the contactless measurement data. The contact type temperature measurement unit 114 may measure the temperature of the measurement target 10 through the window material 130 or the lens 135 to acquire the contact measurement data.

FIG. 9B illustrates a modified example of the temperature measurement device 100. The temperature measurement device 100 of this example is an example of a temperature measurement device that embodies the configuration of FIG. 9A. The window material 130 or the lens 135 may be provided in the vicinity of the tip of the main body part 102 where the semiconductor package 200 is provided to cover the semiconductor package 200. The window material 130 may protect the semiconductor package 200 from dirt or dust. The lens 135 may focus the radiation from the measurement target 10 onto the contactless type temperature measurement unit 112.

In the case where the semiconductor package 200 is covered by the window material 130, the amount of radiation observed by the contactless type temperature measurement unit 112 may be reduced, and the contactless measurement data may change. In addition, in the case where the semiconductor package 200 is covered by the window material 130, the heat conduction properties from the measurement target 10 may change, and the contact measurement data acquired by the contact type temperature measurement unit 114-1 may change. The calculation unit 120 may determine as what percentage of either the maximum or the minimum of the contactless measurement data the temperature of the measurement target 10 is calculated, based on at least one of the material of the window material 130, the thickness of the window material 130, the refractive index of the window material 130, the transmittance of the window material 130, or the thermal conductivity of the window material 130. Similarly, the calculation unit 120 may determine as what percentage of either the maximum or the minimum of the contactless measurement data the temperature of the measurement target 10 is calculated, based on at least one of the material of the lens 135, the shape of the lens 135, the refractive index of the lens 135, the transmittance of the lens 135, or the thermal conductivity of the lens 135.

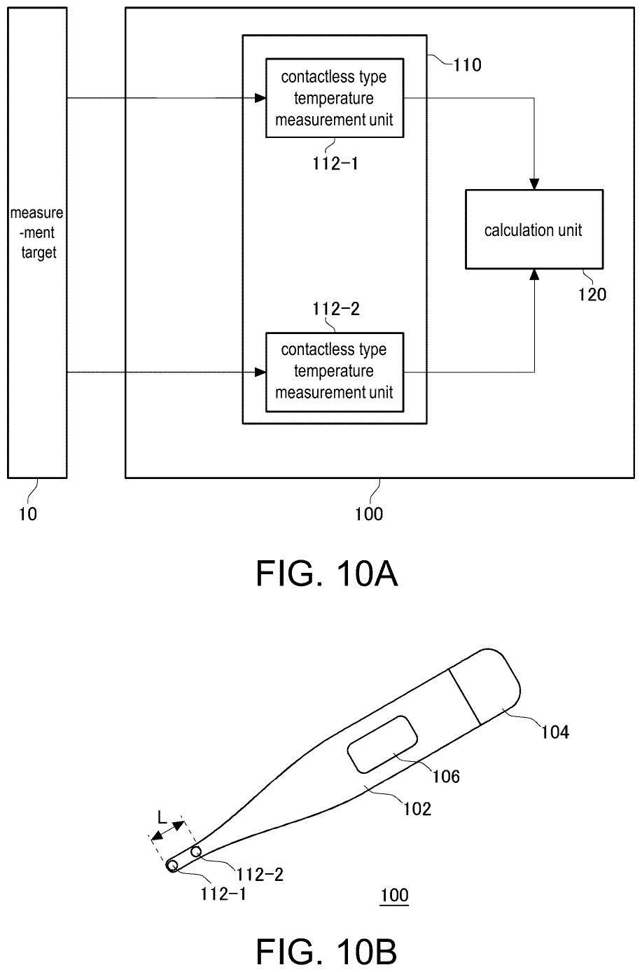

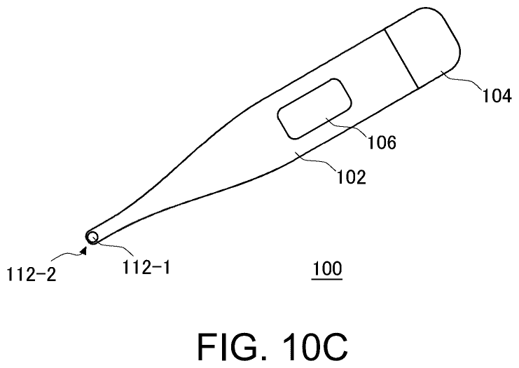

FIG. 10A illustrates a modified example of a configuration of the temperature measurement device 100 together with the measurement target 10. The temperature measurement device 100 of this example includes the temperature measurement module 110 and the calculation unit 120. The temperature measurement module 110 has the first contactless type temperature measurement unit 112-1 and the second contactless type temperature measurement unit 112-2.

The first contactless type temperature measurement unit 112-1 measures the temperature of the measurement target 10 to acquire first contactless measurement data. Details of the first contactless type temperature measurement unit 112-1 are similar to those of the contactless type temperature measurement unit 112 described with reference to FIG. 1A to FIG. 9B.

The second contactless type temperature measurement unit 112-2 measures the temperature of the measurement target 10 to acquire second contactless measurement data. Details of the second contactless type temperature measurement unit 112-2 are similar to those of the contactless type temperature measurement unit 112 described with reference to FIG. 1A to FIG. 9B.

The calculation unit 120 calculates the temperature of the measurement target 10 based on the first contactless measurement data and the second contactless measurement data. Details of the temperature calculation method for the measurement target 10 by the calculation unit 120 will be described later.

FIG. 10B illustrates a modified example of the temperature measurement device 100. The temperature measurement device 100 of this example is an example of a temperature measurement device that embodies the configuration of FIG. 10A.

The first contactless type temperature measurement unit 112-1 may be provided in the vicinity of the tip of the main body part 102. The second contactless type temperature measurement unit 112-2 may be provided on the center side of the main body part 102 relative to the first contactless type temperature measurement unit 112-1 in the vicinity of the tip of the main body part 102.

The distance between the first contactless type temperature measurement unit 112-1 and the second contactless type temperature measurement unit 112-2 may be within 5 cm, and may be within 3 cm. The distance between the first contactless type temperature measurement unit 112-1 and the second contactless type temperature measurement unit 112-2 may be a distance L between the most separated portions of the first contactless type temperature measurement unit 112-1 and the second contactless type temperature measurement unit 112-2. That is, in FIG. 10B, L may be within 5 cm, and may be within 3 cm.

FIG. 10C illustrates a modified example of the temperature measurement device 100. The temperature measurement device 100 of this example is an example of a temperature measurement device that embodies the configuration of FIG. 10A.

The first contactless type temperature measurement unit 112-1 may be provided in the vicinity of the tip of the main body part 102. The second contactless type temperature measurement unit 112-2 may be provided in the vicinity of the tip of the main body part 102. The first contactless type temperature measurement unit 112-1 and the second contactless type temperature measurement unit 112-2 of this example are provided at positions opposite to each other on a circumference in the vicinity of the tip of the main body part 102. That is, in FIG. 10C, the second contactless type temperature measurement unit 112-2 is provided on the back side of the paper.

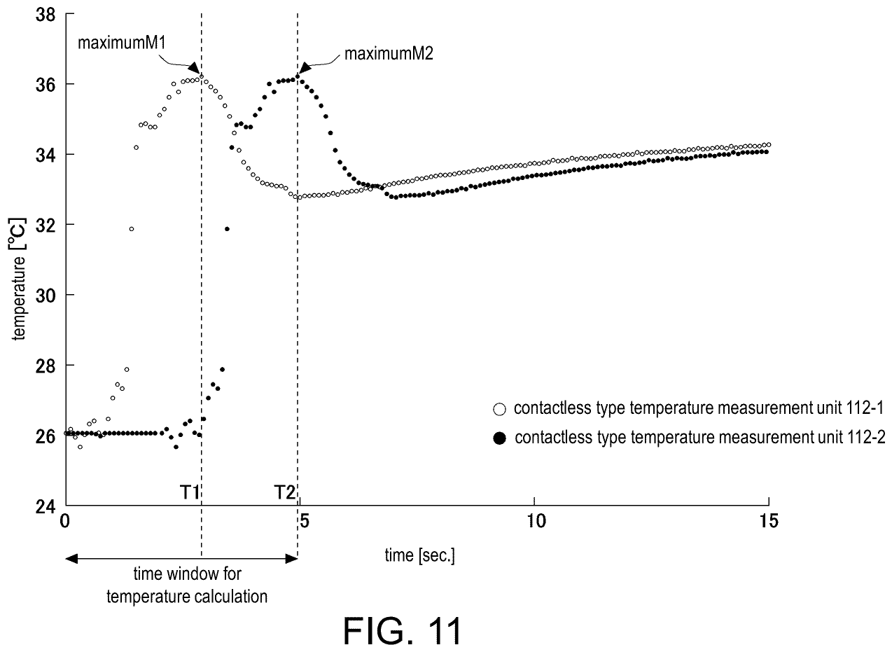

FIG. 11 illustrates an example of the temporal changes of the measurement data. In this figure, the horizontal axis represents time, and the vertical axis represents temperature acquired as measurement data. White circles represent the temperature acquired by the first contactless type temperature measurement unit 112-1 as the first contactless measurement data, and black circles represent the temperature acquired by the second contactless type temperature measurement unit 112-2 as the second contactless measurement data.

The calculation unit 120 may calculate the temperature of the measurement target 10 based on the temporal changes of the first contactless measurement data and the second contactless measurement data. The calculation unit 120 calculates the temperature of the measurement target 10 based on, for example, the temporal changes of the measurement data as illustrated in FIG. 11.

The calculation unit 120 may calculate the temperature of the measurement target 10 based on the temporal changes in the predetermined time window for temperature calculation before or until the time point at which the peaks of both the first contactless measurement data and the second contactless measurement data are observed. For example, the time point at which the peaks of both the first contactless measurement data and the second contactless measurement data are observed may be a time point T2. That is, the peaks of both the first contactless measurement data and the second contactless measurement data do not need to be observed simultaneously, and in the case where there is a difference in the time points at which the peak of the first contactless measurement data and the peak of the second contactless measurement data are observed, a later time point of the time point at which the peak of the first contactless measurement data is observed and the time point at which the peak of the second contactless measurement data is observed may be the time point at which the peaks of both the first contactless measurement data and the second contactless measurement data are observed.

In this example, the peak is the maximum, however, in the case where the temperature of the measurement target 10 is lower than the temperature of the temperature measurement device 100, the peak may be the minimum, which is similar to other examples.

The time window for temperature calculation may be greater than 0 seconds and equal to or less than 15 seconds. The time window for temperature calculation of this example is approximately 5 seconds. However, the invention is not limited to this. The time window for temperature calculation may be a period before or until the time point T2 at which the peaks of both the first contactless measurement data and the second contactless measurement data are observed, and may be a period in which a peak is present in the temporal changes of the contactless measurement data.

The calculation unit 120 may calculate the temperature of the measurement target 10 based on either the maximum or the minimum of the contactless measurement data in the time window for temperature calculation. However, the calculation unit 120 may also calculate the temperature of the measurement target 10 based on other contactless measurement data in the time window for temperature calculation. The contactless measurement data used by the calculation unit 120 to calculate the temperature of the measurement target 10 may be the contactless measurement data before and after the time point at which either the maximum or the minimum is measured. For example, the calculation unit 120 may calculate the temperature of the measurement target 10 based on a value of 90% of either the maximum or the minimum of the contactless measurement data in the time window for temperature calculation. Here, the contactless measurement data used by the calculation unit 120 for calculating the temperature may be either the first contactless measurement data or the second contactless measurement data. For example, the calculation unit 120 calculates the temperature of the measurement target 10 based on the first contactless measurement data in the time window for temperature calculation.

The calculation unit 120 may calculate the temperature of the measurement target 10 as a value of 95% or more and 110% or less of either the maximum or the minimum of the contactless measurement data. The calculation unit 120 may determine as what percentage of either the maximum or the minimum of the contactless measurement data the temperature of the measurement target 10 is calculated, based on the ambient temperature. The calculation unit 120 may determine as what percentage of either the maximum or the minimum of the contactless measurement data the temperature of the measurement target 10 is calculated, based on the humidity of the environment.

As described above, when the temperature measurement device 100 contacts the measurement target 10, the contactless measurement data decreases. Therefore, there is a high probability that the time point T2 at which the peaks of both the first contactless measurement data and the second contactless measurement data are observed is the time point at which the temperature measurement device 100 contacts the measurement target 10. In other words, there is a high probability that, in the vicinity of time point T2, the fields of view of the first contactless type temperature measurement unit 112-1 and the second contactless type temperature measurement unit 112-2 are covered by the measurement target 10. Therefore, by calculating the temperature of the measurement target 10 based on the temporal changes in the predetermined time window for temperature calculation before or until the time point T2, the temperature of the measurement target 10 can be accurately calculated. However, the method for determining the time point at which there is a high probability that the temperature measurement device 100 contacts the measurement target 10, or the time point at which there is a high probability that the fields of view of the first contactless type temperature measurement unit 112-1 and the second contactless type temperature measurement unit 112-2 are covered by the measurement target 10, is not limited. The temperature measurement device 100 may make such a determination by any appropriate method using the contactless measurement data.

The calculation unit 120 may determine whether to calculate the temperature of the measurement target 10 based on the time difference between the time point at which the peak of the first contactless measurement data is observed and the time point at which the peak of the second contactless measurement data is observed. The calculation unit 120 may calculate the temperature of the measurement target 10 in the case where the time difference between the time point at which the peak of the first contactless measurement data is observed and the time point at which the peak of the second contactless measurement data is observed falls within the predetermined reference detection time. The reference detection time may be 2 seconds or more and 5 seconds or less. For example, the reference detection time is 3 seconds.

In the case where the time difference between the time point at which the peak of the first contactless measurement data is observed and the time point at which the peak of the second contactless measurement data is observed is longer than the reference detection time, there is a possibility that the peak occurs due to a factor other than the contact with the measurement target 10. On the other hand, in the case where the time difference between the time point at which the peak of the first contactless measurement data is observed and the time point at which the peak of the second contactless measurement data is observed falls within the reference detection time, there is a high probability that each contactless type temperature measurement unit 112 contacts the measurement target 10. Therefore, the calculation unit 120 may calculate the temperature of the measurement target 10 in the case where the time difference between the time point at which the peak of the first contactless measurement data is observed and the time point at which the peak of the second contactless measurement data is observed falls within the predetermined reference detection time.

As described above, the temperature measurement device 100 of the present example calculates the temperature of the measurement target 10 based on the first contactless measurement data and the second contactless measurement data. Accordingly, the temperature of the measurement target 10 can be accurately calculated.

In the case of calculating the temperature of the measurement target 10 based on the contact measurement data only, time is required until the heat transfer between the temperature measurement device and the measurement target 10 sufficiently progresses, and time may be required until the temperature of the measurement target 10 is calculated. Since the temperature measurement device 100 of the present example calculates the temperature of the measurement target 10 based on the first contactless measurement data and the second contactless measurement data, the temperature of the measurement target 10 can be accurately calculated in a shorter time than the case of calculating the temperature of the measurement target 10 based on the contact measurement data only.

In the above description, the first contactless measurement data has been described as having a peak before the second contactless measurement data, but the order of the peaks of the first contactless measurement data and the second contactless measurement data is not limited to this. For example, in the case of the second contactless measurement data having a peak before the first contactless measurement data, the time point T1 at which the peak of the first contactless measurement data is observed may be the time point at which the peaks of both the first contactless measurement data and the second contactless measurement data are observed, and the calculation unit 120 may calculate the temperature of the measurement target 10 based on the time point T1.

In the above description, the time window for temperature calculation and whether to calculate have been described as being determined based on the peak of the contactless measurement data, but the invention is not limited to this. For example, the time window for temperature calculation and whether to calculate may also be determined based on the time point at which the first contactless measurement data exceeds the predetermined threshold temperature and the time point at which the second contactless measurement data exceeds the threshold temperature. For example, the threshold temperature is 30 degrees.

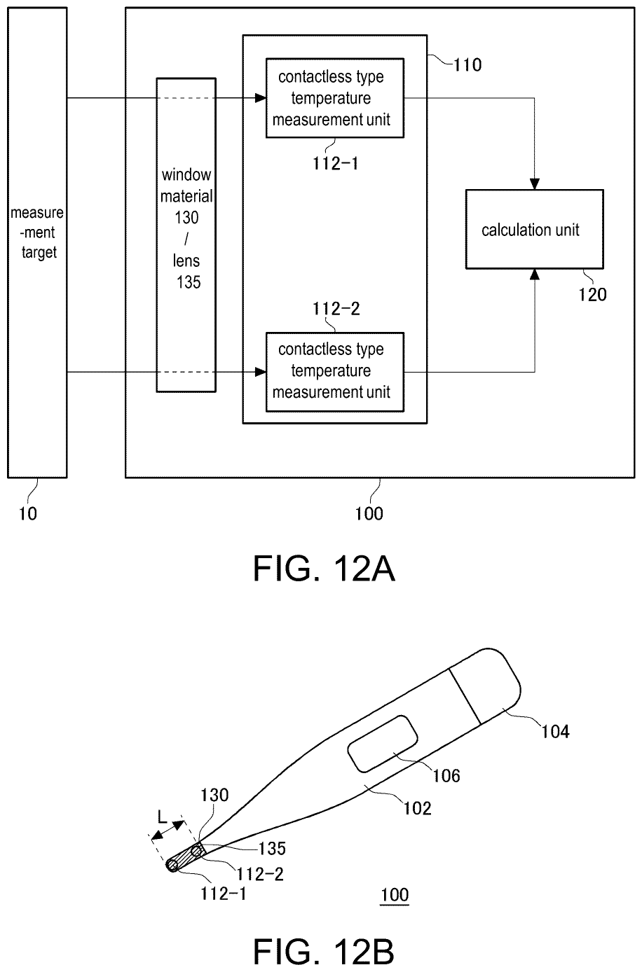

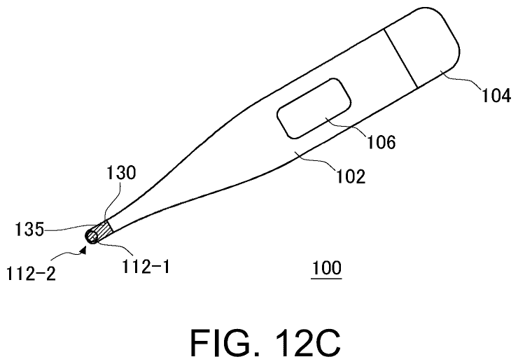

FIG. 12A illustrates a modified example of the configuration of the temperature measurement device 100 together with the measurement target 10. The temperature measurement device 100 of the present example differs from the embodiment of FIG. 10A in that it includes the window material 130 or the lens 135. Other aspects may be the same as the embodiment of FIG. 10A.

The first contactless type temperature measurement unit 112-1 may measure the temperature of the measurement target 10 through the window material 130 or the lens 135 to acquire the first contactless measurement data. The second contactless type temperature measurement unit 112-2 may measure the temperature of the measurement target 10 through the window material 130 or the lens 135 to acquire the second contactless measurement data.

FIG. 12B illustrates a modified example of the temperature measurement device 100. The temperature measurement device 100 of the present example is an example of a temperature measurement device that embodies the configuration of FIG. 12A. The window material 130 or the lens 135 may be provided to cover the temperature measurement module 110 in the vicinity of the tip of the main body part 102 where the temperature measurement module 110 is provided. The window material 130 may protect the temperature measurement module 110 from dirt or dust. The lens 135 may focus the radiation from the measurement target 10 onto the first contactless type temperature measurement unit 112-1 and/or the second contactless type temperature measurement unit 112-2.

The calculation unit 120 may determine as what percentage of either the maximum or the minimum of the contactless measurement data the temperature of the measurement target 10 is calculated, based on at least one of the material of the window material 130, the thickness of the window material 130, the refractive index of the window material 130, the transmittance of the window material 130, or the thermal conductivity of the window material 130. Similarly, the calculation unit 120 may determine as what percentage of either the maximum or the minimum of the contactless measurement data the temperature of the measurement target 10 is calculated, based on at least one of the material of the lens 135, the shape of the lens 135, the refractive index of the lens 135, the transmittance of the lens 135, or the thermal conductivity of the lens 135.

FIG. 12C illustrates a modified example of the temperature measurement device 100. The temperature measurement device 100 of the present example is an example of a temperature measurement device that embodies the configuration of FIG. 12A. The temperature measurement device 100 of the present example differs from the embodiment of FIG. 12B in that the first contactless type temperature measurement unit 112-1 and the second contactless type temperature measurement unit 112-2 are provided at positions opposite to each other on the circumference in the vicinity of the tip of the main body part 102. Other aspects may be the same as the embodiment of FIG. 12B.

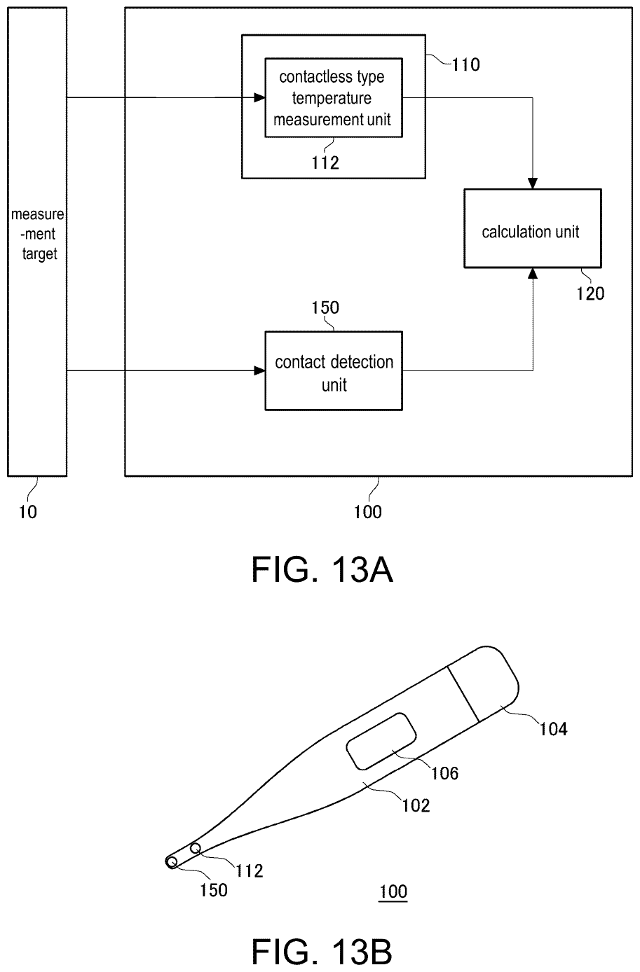

FIG. 13A illustrates a modified example of the configuration of the temperature measurement device 100 together with the measurement target 10. The temperature measurement device 100 of the present example includes the temperature measurement module 110, the calculation unit 120, and the contact detection unit 150. The temperature measurement module 110 has the contactless type temperature measurement unit 112.

The contactless type temperature measurement unit 112 measures the temperature of the measurement target 10 to acquire the contactless measurement data. Details of the contactless type temperature measurement unit 112 are similar to the contactless type temperature measurement unit 112 described with reference to FIG. 1A to FIG. 9B.

The contact detection unit 150 determines the contact state with the measurement target 10 and outputs a contact detection signal. The contact detection unit 150 may have a contact sensor or a proximity sensor. That is, the contact detection unit 150 may determine, as the contact state with the measurement target 10, whether the measurement target 10 is contacted, and may determine whether the measurement target 10 is nearby.

The contact detection unit 150 may output a binary signal of high level or low level as the contact detection signal. The contact detection unit 150 may output a high level signal in the case of determining that the measurement target 10 is contacted or nearby. The contact detection unit 150 may output a low-level signal in the case of determining that the measurement target 10 is not contacted or nearby. However, the levels of the signal output by the contact detection unit 150 may be reversed.

The calculation unit 120 calculates the temperature of the measurement target 10 based on the contactless measurement data and the contact detection signal. Details of the temperature calculation method for the measurement target 10 by the calculation unit 120 will be described later.

FIG. 13B illustrates a modified example of the temperature measurement device 100. The temperature measurement device 100 of the present example is an example of a temperature measurement device that embodies the configuration of FIG. 13A.

The contact detection unit 150 may be provided in the vicinity of the tip of the main body part 102. The contactless type temperature measurement unit 112 may be provided in the vicinity of the tip of the main body part 102, on the center side of the main body part 102 relative to the contact detection unit 150. However, the arrangement of the contactless type temperature measurement unit 112 and the contact detection unit 150 is not limited to this. The contactless type temperature measurement unit 112 may be provided in the vicinity of the tip of the main body part 102, and the contact detection unit 150 may be provided in the vicinity of the tip of the main body part 102, on the center side of the main body part 102 relative to the contactless type temperature measurement unit 112. Alternatively, the contactless type temperature measurement unit 112 and the contact detection unit 150 may also be provided at positions opposite to each other on the circumference in the vicinity of the tip of the main body part 102.

The distance between the contactless type temperature measurement unit 112 and the contact detection unit 150 may be within 5 cm, and may be within 3 cm. The distance between the contactless type temperature measurement unit 112 and the contact detection unit 150 may be the distance L between the most separated portions of the contactless type temperature measurement unit 112 and the contact detection unit 150. That is, in FIG. 13B, L may be within 5 cm, and may be within 3 cm.

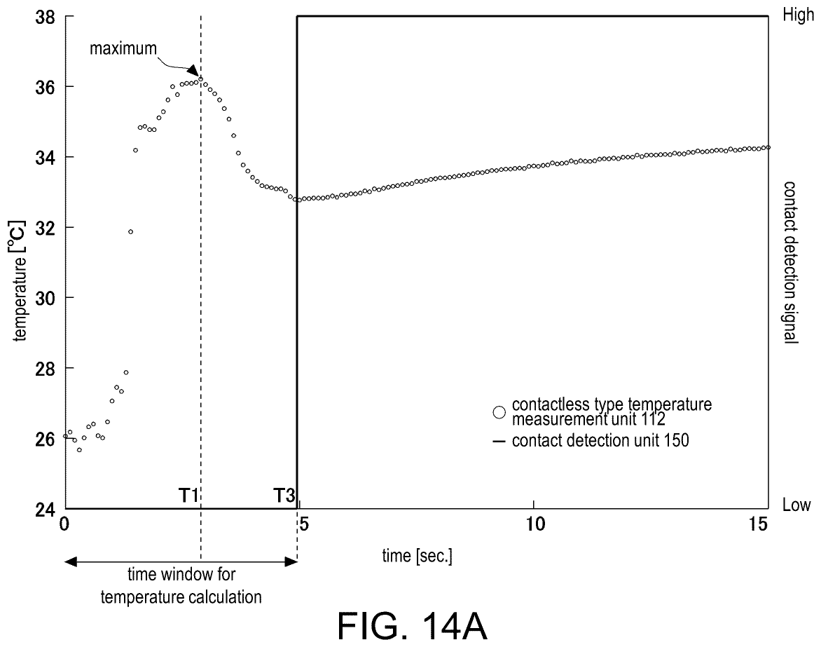

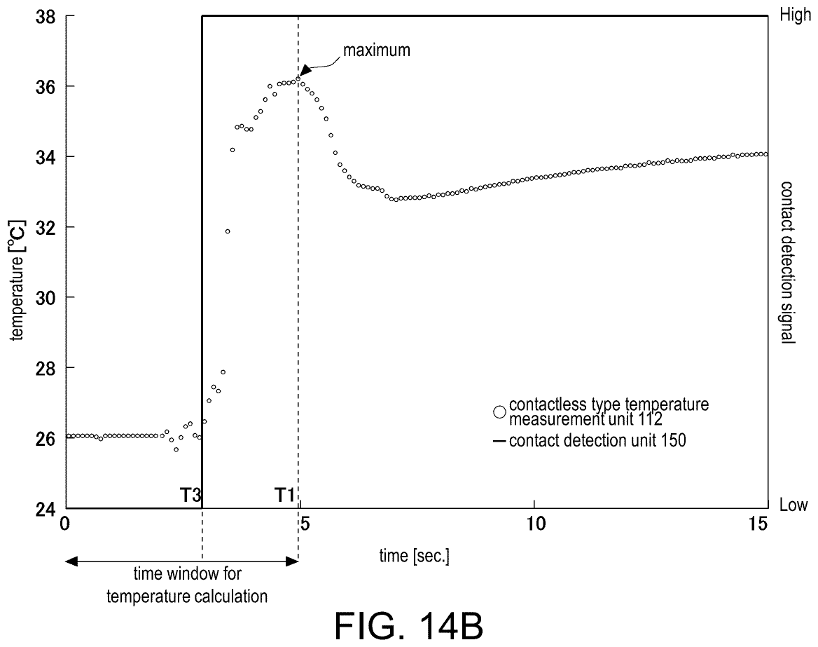

FIG. 14A illustrates an example of the temporal changes of the measurement data and the contact detection signal. In this figure, the horizontal axis represents time, and the vertical axis represents the temperature acquired as the measurement data and the level of the contact detection signal. The white circles represent the temperature acquired by the contactless type temperature measurement unit 112 as the contactless measurement data, and the solid line represents the contact detection signal output by the contact detection unit 150.

The calculation unit 120 may calculate the temperature of the measurement target 10 based on the temporal changes of the contactless measurement data and the contact detection signal. The calculation unit 120 calculates the temperature of the measurement target 10 based on, for example, the temporal changes as illustrated in FIG. 14A.

The calculation unit 120 may calculate the temperature of the measurement target 10 based on the temporal changes in the predetermined time window for temperature calculation before or until the time point at which both the peak of the contactless measurement data and the high-level contact detection signal are observed. For example, the time point at which both the peak of the contactless measurement data and the high-level contact detection signal are observed may be a time point T3. That is, the peak of the contactless measurement data and the high-level contact detection signal do not need to be observed simultaneously, and in the case where there is a difference between the time point at which the peak of the contactless measurement data is observed and the time point at which the high-level contact detection signal is observed, the later time point of the time point at which the peak of the contactless measurement data is observed and the time point at which the high-level contact detection signal is observed may be the time point at which both the peak of the contactless measurement data and the high-level contact detection signal are observed.

In this example, the peak is the maximum, however, in the case where the temperature of the measurement target 10 is lower than the temperature of the temperature measurement device 100, the peak may be the minimum, which is similar to other examples.

The time window for temperature calculation may be greater than 0 seconds and equal to or less than 15 seconds. The time window for temperature calculation in this example is approximately 5 seconds, however, the invention is not limited thereto. The time window for temperature calculation may be a period before or until the time point T3 at which both the peak of the contactless measurement data and the high-level contact detection signal are observed, and may be a period in which the peak in the temporal changes of the contactless measurement data is present.

The calculation unit 120 may calculate the temperature of the measurement target 10 based on either the maximum or the minimum of the contactless measurement data during the time window for temperature calculation. However, the calculation unit 120 may calculate the temperature of the measurement target 10 based on other contactless measurement data during the time window for temperature calculation. The contactless measurement data used by the calculation unit 120 to calculate the temperature of the measurement target 10 may be the contactless measurement data before and after the time point at which either the maximum or the minimum is measured. For example, the calculation unit 120 may calculate the temperature of the measurement target 10 based on a value of 90% of either the maximum or the minimum of the contactless measurement data during the time window for temperature calculation.

The calculation unit 120 may calculate the temperature of the measurement target 10 as a value of 95% or more and 110% or less of either the maximum or the minimum of the contactless measurement data. The calculation unit 120 may determine as what percentage of either the maximum or the minimum of the contactless measurement data the temperature of the measurement target 10 is calculate, based on the ambient temperature. The calculation unit 120 may determine as what percentage of either the maximum or the minimum of the contactless measurement data the temperature of the measurement target 10 is calculated, based on the humidity of the environment.

As described above, when the temperature measurement device 100 contacts the measurement target 10, the contactless measurement data decreases. In addition, when the temperature measurement device 100 contacts or approaches the measurement target 10, the contact detection signal becomes high-level. Therefore, the time point T3 at which both the peak of the contactless measurement data and the high-level contact detection signal are observed has a high probability of being the time point at which the temperature measurement device 100 contacts the measurement target 10. In other words, in the vicinity of the time point T3, there is a high probability that the field of view of the contactless type temperature measurement unit 112 is covered by the measurement target 10. Therefore, by calculating the temperature of the measurement target 10 based on the temporal changes during the predetermined time window for temperature calculation before or until the time point T3, the temperature of the measurement target 10 can be accurately calculated. However, the method for determining the time point at which there is a high probability that the temperature measurement device 100 contacts the measurement target 10, or the time point at which there is a high probability that the field of view of the contactless type temperature measurement unit 112 is covered by the measurement target 10, is not limited. The temperature measurement device 100 may make such determination by any appropriate method using the contactless measurement data and the contact detection signal.

The calculation unit 120 may determine whether to calculate the temperature of the measurement target 10 based on the time difference between the time point at which the peak of the contactless measurement data is observed and the time point at which the high-level contact detection signal is observed. The calculation unit 120 may calculate the temperature of the measurement target 10 in the case where the time difference between the time point at which the peak of the contactless measurement data is observed and the time point at which the high-level contact detection signal is observed is within the predetermined reference detection time. The reference detection time may be 2 seconds or more and 5 seconds or less. For example, the reference detection time is 3 seconds.

In the case where the time difference between the time point at which the peak of the contactless measurement data is observed and the time point at which the high-level contact detection signal is observed is longer than the reference detection time, there is a possibility that the peak and the high-level signal occur due to factors other than contact with the measurement target 10. On the other hand, in the case where the time difference between the time point at which the peak of the contactless measurement data is observed and the time point at which the high-level contact detection signal is observed is within the reference detection time, there is a high probability that the contactless type temperature measurement unit 112 contacts the measurement target 10. Therefore, the calculation unit 120 may calculate the temperature of the measurement target 10 in the case where the time difference between the time point at which the peak of the contactless measurement data is observed and the time point at which the high-level contact detection signal is observed is within the predetermined reference detection time.

As described above, the temperature measurement device 100 of the present example calculates the temperature of the measurement target 10 based on the contactless measurement data and the contact detection signal. Accordingly, the temperature of the measurement target 10 can be accurately calculated.

In the case of calculating the temperature of the measurement target 10 based on the contact measurement data only, time may be required until the heat transfer between the temperature measurement device and the measurement target 10 sufficiently progresses, and time may be required until the temperature of the measurement target 10 is calculated. Since the temperature measurement device 100 of the present example calculates the temperature of the measurement target 10 based on the contactless measurement data and the contact detection signal, the temperature of the measurement target 10 can be accurately calculated in a shorter time than the case of calculating the temperature of the measurement target 10 based on the contact measurement data only.

In the above description, the time window for temperature calculation and whether to calculate are determined based on the peak of the contactless measurement data, but the invention is not limited thereto. For example, the time window for temperature calculation and whether to calculate may be determined based on the time point at which the contactless measurement data exceeds a predetermined threshold temperature and the time point at which the high-level contact detection signal is observed. For example, the threshold temperature is 30 degrees.

FIG. 14B illustrates an example of the temporal changes of the measurement data and the contact detection signal. The present example differs from the example of FIG. 14A in that the peak of the contactless measurement data occurs after the contact detection signal becomes high-level. In the present example, the time point at which both the peak of the contactless measurement data and the high-level contact detection signal are observed may be the time point T1. Other aspects are the same as in FIG. 14A.

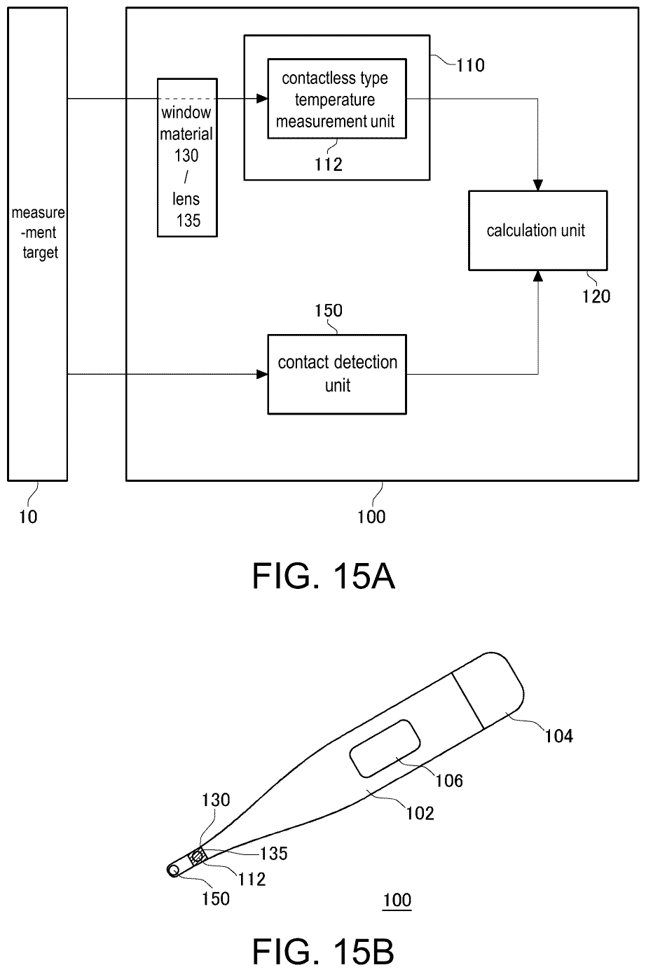

FIG. 15A illustrates a modified example of the configuration of the temperature measurement device 100 together with the measurement target 10. The temperature measurement device 100 of the present example differs from the embodiment of FIG. 13A in that the temperature measurement device 100 includes the window material 130 or the lens 135. Other aspects may be the same as the embodiment of FIG. 13A. The contactless type temperature measurement unit 112 may measure the temperature of the measurement target 10 through the window material 130 or the lens 135 to acquire the contactless measurement data.

FIG. 15B illustrates a modified example of the temperature measurement device 100. The temperature measurement device 100 of the present example is an example of a temperature measurement device that embodies the configuration of FIG. 15A. The window material 130 or the lens 135 may be provided so as to cover the temperature measurement module 110 in the vicinity of the tip of the main body part 102 where the temperature measurement module 110 is provided. The window material 130 may protect the temperature measurement module 110 from dirt or dust. The lens 135 may focus the radiation from the measurement target 10 onto the contactless type temperature measurement unit 112.

The calculation unit 120 may determine as what percentage of either the maximum or the minimum of the contactless measurement data the temperature of the measurement target 10 is calculated, based on at least one of the material of the window material 130, the thickness of the window material 130, the refractive index of the window material 130, the transmittance of the window material 130, or the thermal conductivity of the window material 130. Similarly, the calculation unit 120 may determine as what percentage of either the maximum or the minimum of the contactless measurement data the temperature of the measurement target 10 is calculated, based on at least one of the material of the lens 135, the shape of the lens 135, the refractive index of the lens 135, the transmittance of the lens 135, or the thermal conductivity of the lens 135.

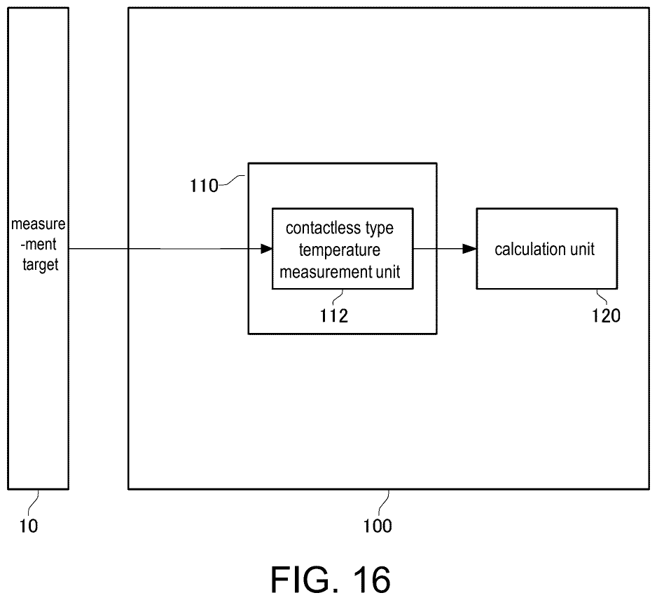

FIG. 16 illustrates an example of the configuration of the temperature measurement device 100 together with the measurement target 10. The temperature measurement device 100 of the present example includes the temperature measurement module 110 and the calculation unit 120. The temperature measurement module 110 has the contactless type temperature measurement unit 112.

The contactless type temperature measurement unit 112 measures the temperature of the measurement target 10 to acquire the contactless measurement data. Details of the contactless type temperature measurement unit 112 may be the same as those described with reference to FIG. 1A to FIG. 15B.

The calculation unit 120 calculates the temperature of the measurement target 10 based on the contactless measurement data. Details of the calculation unit 120 may be the same as those described with reference to FIG. 1A to FIG. 15B.

The calculation unit 120 determines the time point at which the temperature measurement device 100 contacts the measurement target 10. The calculation unit 120 calculates the temperature of the measurement target 10 based on the contactless measurement data of the predetermined time window for temperature calculation before or until the time point determined as the time point at which the temperature measurement device 100 contacts the measurement target 10. The temperature calculation method of the measurement target 10 based on the contactless measurement data of the time window for temperature calculation may be the same as those described with reference to FIG. 1A to FIG. 15B. For example, the calculation unit 120 calculates the temperature of the measurement target 10 based on either the maximum or the minimum of the temporal changes of the contactless measurement data in the time window for temperature calculation.

As an example, the calculation unit 120 may determine the time point at which the temperature measurement device 100 contacts the measurement target 10 based on the contactless measurement data only. As described above, in the case where the temperature of the measurement target 10 is higher than the temperature of the temperature measurement device 100, the contactless measurement data has the maximum. Therefore, the calculation unit 120 may determine the time point at which the maximum occurs in the contactless measurement data as the time point at which the temperature measurement device 100 contacts the measurement target 10. Comparatively, in the case where the temperature of the measurement target 10 is lower than the temperature of the temperature measurement device 100, the contactless measurement data has the minimum. Therefore, the calculation unit 120 may determine the time point at which the minimum occurs in the contactless measurement data as the time point at which the temperature measurement device 100 contacts the measurement target 10. In addition, as described with reference to FIG. 10A to FIG. 12C, the calculation unit 120 may determine the time point at which the temperature measurement device 100 contacts the measurement target 10 based on multiple contactless measurement data.

As another example, the temperature measurement device 100 may include the contact type temperature measurement unit 114 that measures the temperature of the measurement target to acquire the contact measurement data, and the calculation unit 120 may determine the time point of contacting the measurement target 10 based on the contact measurement data. In addition, the calculation unit 120 may determine the time point of contacting the measurement target 10 based on both the contact measurement data and the contactless measurement data. Details of determining the time point of contacting the measurement target 10 based on the contact measurement data, or based on the contact measurement data and the contactless measurement data, are as described with reference to FIG. 1A to FIG. 9B.

As yet another example, the temperature measurement device 100 may include the contact detection unit 150 that determines the contact state with the measurement target 10 and outputs the contact detection signal, and the calculation unit 120 may determine the time point of contacting the measurement target 10 based on the contact detection signal. In addition, the calculation unit 120 may determine the time point of contacting the measurement target 10 based on both the contact detection signal and the contactless measurement data. Details of determining the time point of contacting the measurement target 10 based on the contact detection signal, or based on the contact detection signal and the contactless measurement data, are as described with reference to FIG. 13A to FIG. 15B.

As described above, the calculation unit 120 may determine the contact with the measurement target 10 by any suitable method. In addition, the temperature measurement device 100 may include any suitable configuration for the calculation unit 120 to determine the contact. The method used by the calculation unit 120 for the determination and the configuration included in the temperature measurement device 100 are not limited to the examples described above.

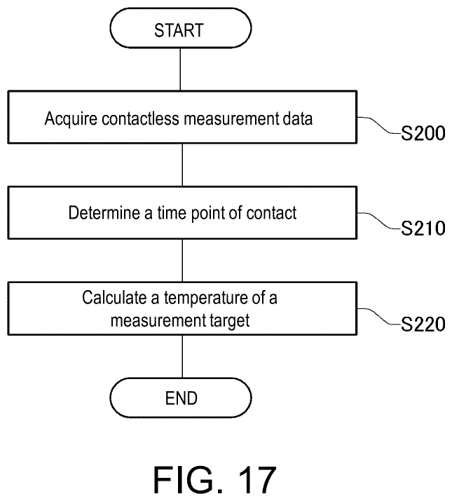

FIG. 17 illustrates an example of a temperature measurement method. The temperature measurement method of this example is a temperature measurement method using the temperature measurement device 100 including the contactless type temperature measurement unit 112 and the calculation unit 120.

In Step S200, the contactless type temperature measurement unit 112 of the temperature measurement device 100 measures the temperature of the measurement target 10 to acquire the contactless measurement data.

In Step S210, the time point at which the temperature measurement device 100 contacts the measurement target 10 is determined. For example, the calculation unit 120 determines the time point at which the temperature measurement device 100 contacts the measurement target 10.

As an example, Step S210 of determining the time point at which the temperature measurement device 100 contacts the measurement target 10 may have a step of determining the time point at which the temperature measurement device 100 contacts the measurement target 10 based on only the contactless measurement data, may have a step of determining the time point at which the temperature measurement device 100 contacts the measurement target 10 based on the maximum or the minimum of the contactless measurement data, and may have a step of determining the time point at which the temperature measurement device 100 contacts the measurement target 10 based on multiple contactless measurement data.

As another example, the temperature measurement method may include a step in which the contact type temperature measurement unit 114 of the temperature measurement device 100 measures the temperature of the measurement target 10 to acquire the contact measurement data, and Step S210 of determining the time point at which the temperature measurement device 100 contacts the measurement target 10 may have a step of determining the time point of contacting the measurement target 10 based on the contact measurement data. In addition, Step S210 of determining the time point at which the temperature measurement device 100 contacts the measurement target 10 may have a step of determining the time point of contacting the measurement target 10 based on both the contact measurement data and the contactless measurement data. Details of determining the time point of contacting the measurement target 10 based on the contact measurement data, or based on the contact measurement data and the contactless measurement data, are as described with reference to FIG. 1A to FIG. 9B.

As still another example, the temperature measurement method may include a step in which the contact detection unit 150 of the temperature measurement device 100 determines the contact state with the measurement target 10 and outputs the contact detection signal, and Step S210 of determining the time point at which the temperature measurement device 100 contacts the measurement target 10 may have a step of determining the time point of contacting the measurement target 10 based on the contact detection signal. In addition, Step S210 of determining the time point at which the temperature measurement device 100 contacts the measurement target 10 may have a step of determining the time point of contacting the measurement target 10 based on the contact detection signal and the contactless measurement data. Details of determining the time point of contacting the measurement target 10 based on the contact detection signal, or based on the contact detection signal and the contactless measurement data, are as described with reference to FIG. 13A to FIG. 15B.

As described above, Step S210 of determining the time point at which the temperature measurement device 100 contacts the measurement target 10 may be realized by any suitable method. In addition, the temperature measurement device 100 may include any suitable configuration for determining the contact. The method for realizing Step S210 of determining the time point at which the temperature measurement device 100 contacts the measurement target 10 and the configuration included in the temperature measurement device 100 are not limited to the above examples.

In Step S220, the temperature of the measurement target 10 is calculated based on the contactless measurement data during the predetermined time window for temperature calculation before or until the time point determined as the time point at which the temperature measurement device 100 contacts the measurement target 10. The temperature calculation method for the measurement target 10 based on the contactless measurement data during the time window for temperature calculation may be similar to that described with reference to FIG. 1A to FIG. 15B. For example, Step S220 of calculating the temperature of the measurement target 10 has a step of calculating the temperature of the measurement target 10 based on either the maximum or the minimum of the temporal changes of the contactless measurement data during the time window for temperature calculation.

As described above, the temperature measurement method and the temperature measurement device 100 of the present example determine the time point at which the temperature measurement device 100 contacts the measurement target 10, and calculate the temperature of the measurement target 10 based on the contactless measurement data during the time window for temperature calculation before the determined time point. This enables accurate calculation of the temperature of the measurement target 10.

Various embodiments of the invention may be described with reference to flowcharts and block diagrams, where blocks may represent (1) stages of a process in which operations are performed or (2) sections of a device having a role of performing operations. Specific stages and sections may be implemented by dedicated circuits, programmable circuits supplied with computer readable instructions stored on computer readable media, and/or processors supplied with computer readable instructions stored on computer readable media. Dedicated circuits may include digital and/or analog hardware circuits, and may include integrated circuits (IC) and/or discrete circuits. Programmable circuits may include reconfigurable hardware circuits including memory elements such as logical AND, logical OR, logical XOR, logical NAND, logical NOR, and other logical operations, flip-flops, registers, field programmable gate arrays (FPGA), programmable logic arrays (PLA), and the like.

The computer readable medium may include any tangible device capable of storing instructions executed by an appropriate device, and, as a result, a computer readable medium having instructions stored therein may include a product including instructions that can be executed to create means for executing operations specified in flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy (registered trademark) disk, a diskette, hard disk, a random access memory (RAM), a read only memory (ROM), an erasable programmable read only memory (EPROM or flash memory), an electrically erasable programmable read only memory (EEPROM), a static random access memory (SRAM), a compact disc read only memory (CD-ROM), a digital versatile disc (DVD), a Blu-ray (RTM) disc, memory stick, an integrated circuit card, and the like.

The computer readable instructions may include either source codes or object codes written in any combination of one or more programming languages, including assembler instructions, instruction set architecture (ISA) instructions, machine instructions, machine dependent instructions, microcode, firmware instructions, state setting data, or object oriented programming languages such as Smalltalk (registered trademark), JAVA (registered trademark), C++, and the like, and conventional procedural programming languages such as the “C” programming language or similar programming languages.

Computer readable instructions may be provided to a processor or a programmable circuit of a programmable data processing device such as a computer, either locally or via a wide area network (WAN) such as a local area network (LAN), the Internet, or the like, and the computer readable instructions may be executed to create means for executing operations specified in flowcharts or block diagrams. Here, the computer may be a personal computer (PC), a tablet computer, a smartphone, a workstation, a server computer, a general-purpose computer, or a special-purpose computer, or the like, and may be a computer system in which multiple computers are connected. Such a computer system in which multiple computers are connected is also referred to as a distributed computing system, and is a computer in a broad sense. In a distributed computing system, each of the computers executes a portion of a program, and data during program execution is passed between computers as necessary. Accordingly, the computers collectively execute the program.

Examples of processors include computer processors, central processing units (CPUs), processing units, microprocessors, digital signal processors, controllers, microcontrollers, and the like. A computer may include one processor or multiple processors. In a multiprocessor system including multiple processors, each processor executes a portion of a program, and by passing data during program execution between processors as needed, the processors collectively execute the program. For example, in the execution of multitasking, each of the processors may execute a portion of each task each in small pieces by performing task switching for each time slice. In this case, which portion of one program each processor executes changes dynamically. Which portion of the program each of the processors executes may also be defined statically by programming that is aware of multiprocessors.

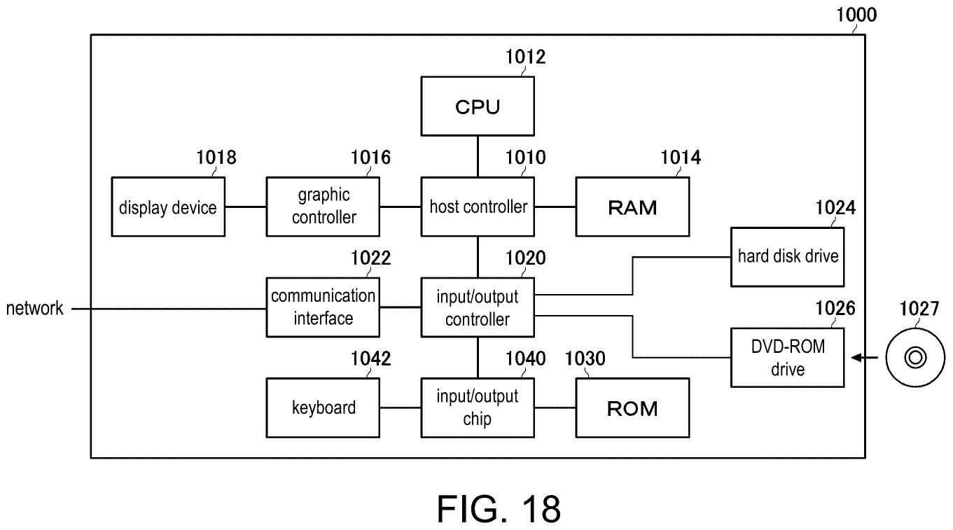

FIG. 18 illustrates an example of a computer 1000 in which multiple aspects of the invention may be embodied in whole or in part. A program installed in the computer 1000 can cause the computer 1000 to serve as operations associated with a device according to an embodiment of the invention or as one or multiple sections of the device, or can cause the computer 1000 to execute the operations or the one or multiple sections, and/or can cause the computer 1000 to execute a process according to an embodiment of the invention or stages of the process. Such a program may be executed by the CPU 1012 to cause the computer 1000 to execute specific operations associated with some or all of the flowcharts and the blocks of the block diagrams described in the specification.

The computer 1000 according to the embodiment includes a CPU 1012, the RAM 1014, a graphic controller 1016, and a display device 1018, which are mutually connected by a host controller 1010. The computer 1000 also includes input/output units such as a communication interface 1022, a hard disk drive 1024, a DVD-ROM drive 1026, and an IC card drive, which are connected to the host controller 1010 via an input/output controller 1020. The computer also includes legacy input/output units such as a ROM 1030 and a keyboard 1042, which are connected to the input/output controller 1020 via an input/output chip 1040.

The CPU 1012 operates according to programs stored in the ROM 1030 and the RAM 1014, thereby controlling each unit. The graphic controller 1016 acquires image data generated by the CPU 1012 in a frame buffer or the like provided in the RAM 1014 or in itself, and causes the image data to be displayed on the display device 1018.

The communication interface 1022 communicates with other electronic devices via a network. The hard disk drive 1024 stores programs and data used by the CPU 1012 in the computer 1000. The DVD-ROM drive 1026 reads the programs or data from the DVD-ROM 1027, and provides the programs or data to the hard disk drive 1024 via the RAM 1014. The IC card drive reads the programs and data from an IC card, and/or writes programs and data to the IC card.

The ROM 1030 stores therein a boot program or the like executed by the computer 1000 at the time of activation, and/or a program dependent on the hardware of the computer 1000. The input/output chip 1040 may also connect various input/output units to the input/output controller 1020 via a parallel port, a serial port, a keyboard port, a mouse port, or the like.

The program is provided by a computer readable medium such as the DVD-ROM 1027 or an IC card. The program is read from the computer readable medium, installed in the hard disk drive 1024, the RAM 1014, or the ROM 1030 which is also an example of the computer readable medium, and executed by the CPU 1012. The information processing described in the programs is read by the computer 1000 and brings about the cooperation between the programs and various types of hardware resources above. A device or method may be configured by realizing manipulation or processing of information according to the use of the computer 1000.

For example, in the case where the communication is executed between the computer 1000 and an external device, the CPU 1012 may execute a communication program loaded to the RAM 1014, and instruct the communication interface 1022 to perform communication processing based on the process described in the communication program. The communication interface 1022, under the control of the CPU 1012, reads the transmission data stored in a transmission buffer processing area provided in a recording medium such as the RAM 1014, the hard disk drive 1024, the DVD-ROM 1027, or an IC card, transmits the read transmission data to a network, or writes reception data received from the network to a reception buffer processing area or the like provided in the recording medium.

In addition, the CPU 1012 may cause all or a necessary portion of a file or a database stored in an external recording medium such as the hard disk drive 1024, the DVD-ROM drive 1026 (DVD-ROM 1027), an IC card, or the like to be read into the RAM 1014, and may execute various types of processing on the data on the RAM 1014. The CPU 1012 then writes back the processed data to the external recording medium.

Various types of information such as various types of programs, data, tables, and databases may be stored in the recording medium and may be subjected to information processing. The CPU 1012 may execute various types of processing on data read from the RAM 1014, including various types of operations, information processing, condition judgment, conditional branching, unconditional branching, information search/replacement, and the like, described throughout the invention and specified by instruction sequences of programs, and write back the results to the RAM 1014. Also, the CPU 1012 may search for information in files, databases, and the like in the recording medium. For example, in the case where multiple entries each having an attribute value of a first attribute associated with an attribute value of a second attribute are stored in the recording medium, the CPU 1012 may search for an entry matching a condition in which an attribute value of the first attribute is specified from among the entries, read an attribute value of the second attribute stored in the entry, and thereby acquire an attribute value of the second attribute associated with the first attribute satisfying a predetermined condition.

The program or software module described above may be stored in a computer readable medium on the computer 1000 or in the vicinity of the computer 1000. Also, a recording medium such as a hard disk or RAM provided in a server system connected to a dedicated communication network or the Internet can be used as a computer readable medium, thereby providing the program to the computer 1000 via the network.

The embodiment may be specified by the following items.

### Item 1

A temperature measurement method includes: a step of measuring, by a contactless type temperature measurement unit of a temperature measurement device, a temperature of a measurement target to acquire contactless measurement data; a step of determining a time point at which the temperature measurement device contacts the measurement target; and a step of calculating the temperature of the measurement target based on the contactless measurement data during a predetermined time window for temperature calculation before or until a time point determined as the time point at which the temperature measurement device contacts the measurement target.

### Item 2

In the temperature measurement method according to Item 1, the step of calculating the temperature of the measurement target includes: a step of calculating the temperature of the measurement target based on any one of a maximum or a minimum of temporal changes of the contactless measurement data during the time window for temperature calculation.

### Item 3

The temperature measurement method according to Item 1 includes: a step of measuring, by a contact type temperature measurement unit of the temperature measurement device, the temperature of the measurement target and acquiring contact measurement data. The step of determining the time point at which the temperature measurement device contacts the measurement target includes: a step of determining the time point of contacting the measurement target based on the contact measurement data.

### Item 4

The temperature measurement method according to Item 1 includes: a step of measuring, by a contact type temperature measurement unit of the temperature measurement device, the temperature of the measurement target and acquiring contact measurement data. The step of determining the time point at which the temperature measurement device contacts the measurement target includes: a step of determining the time point of contacting the measurement target based on both the contact measurement data and the contactless measurement data.

### Item 5

The temperature measurement method according to Item 1 includes: a step of measuring, by a contact type temperature measurement unit of the temperature measurement device, the temperature of the measurement target and acquiring contact measurement data. The step of calculating the temperature of the measurement target includes: a step of calculating the temperature of the measurement target based on the contactless measurement data and the contact measurement data.

### Item 6

In the temperature measurement method according to Item 5, the step of acquiring the contactless measurement data includes: a step of acquiring the contactless measurement data in a state where the temperature measurement device does not contact the measurement target; and a step of acquiring the contactless measurement data in a state where the temperature measurement device contacts the measurement target.

### Item 7

In the temperature measurement method according to Item 5, the step of calculating the temperature of the measurement target includes: a step of calculating the temperature of the measurement target based on temporal changes of the contactless measurement data and the contact measurement data.

### Item 8

In the temperature measurement method according to Item 5, the step of determining the time point at which the temperature measurement device contacts the measurement target includes: a step of determining a time point at which the contactless measurement data decreases and the contact measurement data increases as the time point of contacting the measurement target.

### Item 9

The temperature measurement method according to Item 5 includes a step of notifying an error in a case where an amount of change of the contact measurement data acquired by the contact type temperature measurement unit does not exceed a predetermined error reference value within a predetermined error determination period.

### Item 10

In the temperature measurement method according to Item 1, the step of acquiring the contactless measurement data includes: a step of measuring, by a first contactless type temperature measurement unit of the temperature measurement device, the temperature of the measurement target and acquiring first contactless measurement data; and a step of measuring, by a second contactless type temperature measurement unit of the temperature measurement device, the temperature of the measurement target and acquiring second contactless measurement data. In addition, the step of calculating the temperature of the measurement target includes: a step of calculating the temperature of the measurement target based on the first contactless measurement data and the second contactless measurement data.

### Item 11

The temperature measurement method according to Item 1 includes: a step of determining, by a contact detection unit of the temperature measurement device, a contact state with the measurement target and outputting a contact detection signal. The step of determining the time point at which the temperature measurement device contacts the measurement target includes: a step of determining the time point of contacting the measurement target based on the contact detection signal.

### Item 12

In the temperature measurement method according to any one of Items 1 to 11, the time window for temperature calculation is greater than 0 seconds and equal to or less than 15 seconds.

### Item 13

In the temperature measurement method according to any one of Items 1 to 11, the step of calculating the temperature of the measurement target includes: a step of calculating the temperature of the measurement target as a value of 95% or more and 110% or less of any one of a maximum or a minimum of the contactless measurement data.

### Item 14

In the temperature measurement method according to any one of Items 1 to 11, the step of acquiring the contactless measurement data includes: a step of acquiring the contactless measurement data at a time interval of 0.004 seconds or more and 5 seconds or less.

### Item 15

In the temperature measurement method according to any one of Items 3 to 9, the contactless type temperature measurement unit and the contact type temperature measurement unit are provided in a common semiconductor package.

### Item 16

In the temperature measurement method according to any one of Items 1 to 11, the contactless type temperature measurement unit includes: a quantum type infrared sensor.

### Item 17

In the temperature measurement method according to any one of Items 1 to 11, the measurement target is a living organism.

### Item 18

A temperature measurement device includes: a contactless temperature measurement unit, measuring a temperature of a measurement target to acquire contactless measurement data; and a calculation unit, calculating the temperature of the measurement target based on the contactless measurement data. The calculation unit determines a time point at which the temperature measurement device contacts the measurement target. In addition, the calculation unit calculates the temperature of the measurement target based on the contactless measurement data during a predetermined time window for temperature calculation before or until a time point determined as the time point at which the temperature measurement device contacts the measurement target.

### Item 19

In the temperature measurement device according to Item 18, the calculation unit calculates the temperature of the measurement target based on any one of a maximum or a minimum of temporal changes of the contactless measurement data during the time window for temperature calculation.

### Item 20

The temperature measurement device according to Item 18 includes: a contact type temperature measurement unit, measuring the temperature of the measurement target and acquiring contact measurement data. The calculation unit determines the time point of contacting the measurement target based on the contact measurement data.

### Item 21

The temperature measurement device according to Item 18 includes: a contact type temperature measurement unit, measuring the temperature of the measurement target and acquiring contact measurement data. The calculation unit determines the time point of contacting the measurement target based on both the contact measurement data and the contactless measurement data.

### Item 22

The temperature measurement device according to Item 18 includes: a contact type temperature measurement unit, measuring the temperature of the measurement target and acquiring contact measurement data. The calculation unit calculates the temperature of the measurement target based on the contactless measurement data and the contact measurement data.

### Item 23

In the temperature measurement device according to Item 22, the calculation unit calculates the temperature of the measurement target based on temporal changes of the contactless measurement data and the contact measurement data.

### Item 24

In the temperature measurement device according to Item 22, the calculation unit determines a time point at which the contactless measurement data decreases and the contact measurement data increases as the time point of contacting the measurement target.

### Item 25

The temperature measurement device according to Item 22 notifies an error in a case where an amount of change of the contact measurement data acquired by the contact type temperature measurement unit does not exceed a predetermined error reference value within a predetermined error determination period.

### Item 26

In the temperature measurement device according to Item 18, the contactless temperature measurement unit includes: a first contactless type temperature measurement unit, measuring the temperature of the measurement target and acquiring first contactless measurement data; and a second contactless type temperature measurement unit, measuring the temperature of the measurement target and acquiring second contactless measurement data. The calculation unit calculates the temperature of the measurement target based on the first contactless measurement data and the second contactless measurement data.

### Item 27

The temperature measurement device according to Item 18 includes a contact detection unit, determining a contact state with the measurement target and outputting a contact detection signal. The calculation unit determines the time point of contacting the measurement target based on the contact detection signal.

### Item 28

In the temperature measurement device according to any one of Items 18 to 27, the time window for temperature calculation is greater than 0 seconds and equal to or less than 15 seconds.

### Item 29

In the temperature measurement device according to any one of Items 18 to 27, the calculation unit calculates the temperature of the measurement target as a value of 95% or more and 110% or less of any one of a maximum or a minimum of the contactless measurement data.

### Item 30

In the temperature measurement device according to any one of Items 18 to 27, the contactless temperature measurement unit acquires the contactless measurement data at a time interval of 0.004 seconds or more and 5 seconds or less.

### Item 31

In the temperature measurement device according to any one of Items 20 to 25, the contactless type temperature measurement unit and the contact type temperature measurement unit are provided in a common semiconductor package.

### Item 32

In the temperature measurement device according to any one of Items 20 to 25, a distance between the contactless type temperature measurement unit and the contact type temperature measurement unit is 3 cm or less.

### Item 33

In the temperature measurement device according to any one of Items 18 to 27, the contactless type temperature measurement unit includes: a quantum type infrared sensor.

### Item 34

A program is provided. When executed by a computer, the program causes the computer to: control a contactless type temperature measurement unit of a temperature measurement device to measure a temperature of a measurement target and acquire contactless measurement data, determine a time point at which the temperature measurement device contacts the measurement target, and calculate a temperature of the measurement target based on the contactless measurement data during a predetermined time window for temperature calculation before or until a time point determined as the time point at which the temperature measurement device contacts the measurement target.

### Item 35

In the program according to Item 34, when executed by the computer, the program causes the computer to: control a contact type temperature measurement unit of the temperature measurement device to measure the temperature of the measurement target and acquire contact measurement data, and calculate the temperature of the measurement target based on the contact measurement data and the contactless measurement data.

### Item 36

In the program according to Item 34, controlling the contactless type temperature measurement unit of the temperature measurement device to acquire the contactless measurement data includes: controlling a first contactless type temperature measurement unit of the temperature measurement device to measure the temperature of the measurement target and acquire first contactless measurement data, and controlling a second contactless type temperature measurement unit of the temperature measurement device to measure the temperature of the measurement target and acquire second contactless measurement data. In addition, when executed by the computer, the program causes the computer to: calculate the temperature of the measurement target based on the first contactless measurement data and the second contactless measurement data.

### Item 37

In the program according to Item 34, when executed by the computer, the program causes the computer to: control a contact detection unit of the temperature measurement device to determine a contact state with the measurement target and output a contact detection signal, and determine a time point of contacting the measurement target based on the contact detection signal.

As described above, the invention has been described by using the embodiments, but the technical scope of the invention is not limited to the scope described in the embodiments. It is apparent to those skilled in the art that various changes or improvements can be added to the embodiments. It is apparent from the description of the claims that forms with such changes or improvements added may still fall within in the technical scope of the invention.

It should be noted that the execution order of the respective processes such as operations, procedures, steps, and stages in the devices, systems, programs, and methods indicated in the claims, specification, and drawings can be realized in any order unless specifically indicated as “before” or “prior to”, and unless the output of the previous process is used in the subsequent process. Even if the operation flow in the claims, specification, and drawings is described by using “first,” “next,” etc., for the convenience, this does not mean that it is essential to implement in this order.

What is claimed is:

1. A temperature measurement method, comprising:
a step of measuring, by a contactless type temperature measurement unit of a temperature measurement device, a temperature of a measurement target to acquire contactless measurement data;
a step of determining a time point at which the temperature measurement device contacts the measurement target; and
a step of calculating the temperature of the measurement target based on the contactless measurement data during a predetermined time window for temperature calculation before or until a time point determined as the time point at which the temperature measurement device contacts the measurement target.

2. The temperature measurement method as claimed in claim 1, wherein the step of calculating the temperature of the measurement target comprises: a step of calculating the temperature of the measurement target based on any one of a maximum or a minimum of temporal changes of the contactless measurement data during the time window for temperature calculation.

3. The temperature measurement method as claimed in claim 1, comprising:
a step of measuring, by a contact type temperature measurement unit of the temperature measurement device, the temperature of the measurement target and acquiring contact measurement data,
wherein the step of determining the time point at which the temperature measurement device contacts the measurement target comprises: a step of determining the time point of contacting the measurement target based on the contact measurement data.

4. The temperature measurement method as claimed in claim 1, comprising:
a step of measuring, by a contact type temperature measurement unit of the temperature measurement device, the temperature of the measurement target and acquiring contact measurement data,
wherein the step of determining the time point at which the temperature measurement device contacts the measurement target comprises: a step of determining the time point of contacting the measurement target based on both the contact measurement data and the contactless measurement data.

5. The temperature measurement method as claimed in claim 1, comprising:
a step of measuring, by a contact type temperature measurement unit of the temperature measurement device, the temperature of the measurement target and acquiring contact measurement data,
wherein the step of calculating the temperature of the measurement target comprises: step of calculating the temperature of the measurement target based on the contactless measurement data and the contact measurement data.

6. The temperature measurement method as claimed in claim 5, wherein the step of acquiring the contactless measurement data comprises:
a step of acquiring the contactless measurement data in a state where the temperature measurement device does not contact the measurement target; and
a step of acquiring the contactless measurement data in a state where the temperature measurement device contacts the measurement target.

7. The temperature measurement method as claimed in claim 5, wherein the step of calculating the temperature of the measurement target comprises: a step of calculating the temperature of the measurement target based on temporal changes of the contactless measurement data and the contact measurement data.

8. The temperature measurement method as claimed in claim 5, wherein the step of determining the time point at which the temperature measurement device contacts the measurement target comprises: a step of determining a time point at which the contactless measurement data decreases and the contact measurement data increases as the time point of contacting the measurement target.

9. The temperature measurement method as claimed in claim 5, comprising a step of notifying an error in a case where an amount of change of the contact measurement data acquired by the contact type temperature measurement unit does not exceed a predetermined error reference value within a predetermined error determination period.

10. The temperature measurement method as claimed in claim 1, wherein the step of acquiring the contactless measurement data comprises:
a step of measuring, by a first contactless type temperature measurement unit of the temperature measurement device, the temperature of the measurement target and acquiring first contactless measurement data; and
a step of measuring, by a second contactless type temperature measurement unit of the temperature measurement device, the temperature of the measurement target and acquiring second contactless measurement data, and
the step of calculating the temperature of the measurement target comprises: a step of calculating the temperature of the measurement target based on the first contactless measurement data and the second contactless measurement data.

11. The temperature measurement method as claimed in claim 1, comprising:
a step of determining, by a contact detection unit of the temperature measurement device, a contact state with the measurement target and outputting a contact detection signal,
wherein the step of determining the time point at which the temperature measurement device contacts the measurement target comprises: a step of determining the time point of contacting the measurement target based on the contact detection signal.

12. The temperature measurement method as claimed in claim 1, wherein the time window for temperature calculation is greater than 0 seconds and equal to or less than 15 seconds.

13. The temperature measurement method as claimed in claim 1, wherein the step of calculating the temperature of the measurement target comprises: a step of calculating the temperature of the measurement target as a value of 95% or more and 110% or less of any one of a maximum or a minimum of the contactless measurement data.

14. The temperature measurement method as claimed in claim 1, wherein the step of acquiring the contactless measurement data comprises: a step of acquiring the contactless measurement data at a time interval of 0.004 seconds or more and 5 seconds or less.

15. The temperature measurement method as claimed in claim 3, wherein the contactless type temperature measurement unit and the contact type temperature measurement unit are provided in a common semiconductor package.

16. The temperature measurement method as claimed in claim 1, wherein the contactless type temperature measurement unit comprises: a quantum type infrared sensor.

17. The temperature measurement method as claimed in claim 1, wherein the measurement target is a living organism.
